(19) United States
(12) Patent Application Publication
(10) Pub. No.: US 2025/0138204 A1
(43) Pub. Date: May 1, 2025

(54) DOPANT-FREE COPPER-BASED PEROVSKITE-ANALOGUE INORGANIC THIN-FILM SCINTILLATOR FOR CHARGED PARTICLE DETECTION

(71) Applicants: SZEGEDI TUDOMÁNYEGYETEM, Szeged (HU); HUN-REN ATOMMAGKUTATÓ INTÉZET, Debrecen (HU)

(72) Inventors: Csaba JANÁKY, Szeged (HU); Gergely Ferenc SAMU, Szeged (HU); Mátyás HUNYADI, Debrecen (HU); Attila CSÍK, Debrecen (HU); Lóránt CSIGE, Debrecen (HU); Csaba BUGA, Nyírpazony (HU)

(21) Appl. No.: 18/694,706

(22) PCT Filed: Sep. 15, 2022
(86) PCT No.: PCT/HU2022/050066

§ 371 Date: Mar. 22, 2024

(30) Foreign Application Priority Data
Sep. 22, 2021 (HU) P2100329

(51) Int. Cl. G01T 1/202; C09K 11/58; C09K 11/61; G21K 4/00

(52) U.S. Cl. CPC G01T 1/2023; C09K 11/58; C09K 11/616; G21K 4/00

(57) ABSTRACT

The invention relates to a scintillation unit to detect charged particles, the use of the scintillation unit for the detection of charged particles, preparation processes of said scintillation unit, as well as a charged particle detection device.

The scintillator unit comprises a perovskite-analogue luminescent substance with a luminescent peak of a general chemical formula of either AₓB₃₋ₓCu₂X_{y}Y_{5-y} with 0≤x≤3, 0≤y≤5 or AₓB₁₋ₓCu₂X_{y}Y_{3-y} with 0≤x≤1, 0≤y≤3, wherein any of A and B is a monovalent alkali metal cation, and any of X and Y is a monovalent halogen element anion or a pseudohalide, arranged on a substrate as thin-film having a given film-thickness, wherein the substrate is transparent at least in the wavelength range of the luminescent peak of said luminescent substance.

### FIELD OF THE INVENTION

The present invention relates to the field of charged particle detection. In particular, the invention relates to processes producing dopant-free copper-based perovskite-analogue inorganic thin-film scintillators, as well as the use thereof for charged particle detection, specifically for the detection of electrons, protons, alpha particles, ionic species of chemical elements of the Periodic Table of Elements and ionic species of molecules, as well as heavy ions, preferably in the form of e.g. fission fragments, all with a unified atomic mass unit of at most 150, from external sources. The invention also relates to novel scintillation detectors built with said inorganic thin-film scintillators that are also capable of separating detection signals of said charged particles from those of electromagnetic radiation, as well as separating detection signal of different types of said charged particles.

### BACKGROUND ART

Charged particle detection is of great importance in many fields of fundamental research, such as nuclear physics, high-energy particle physics or space research, as well as applications including environmental monitoring of radioisotopes for both industrial and defence purposes, dosimetry, or mass spectrometry, just to mention a few. Nuclear radiation detectors are thus broadly discussed in literature, see e.g. the book “Nuclear Radiation Detectors” by S. S. Kapoor and V. S. Ramamurthy [published by New Age International Ltd., New-Delhi, India, (1986, reprint: 2005); ISBN: 0-85226-496-8].

The two most prevalent solutions for charged particle detection are based on the use of semiconductor charge-collection devices and ionization chambers. The former solution is favourable when spectroscopic information is needed with high precision. However, semiconductor charge-collection devices have several major drawbacks due to their high sensitivity to radiation damage, need of special operational conditions, for example cooling, and long charge-integration time, which makes them unsuitable for high-rate measurements and precise timing applications. Ionization chambers show the opposite characteristics in all sense. The ionization chambers are constructed of a gas chamber and specific electrodes that are tuned near the breakdown voltage of the filling gas. An ionization event in the gas volume following the impact of charged particles evolves to an avalanche breakdown, which, on the one hand, results in a fast electric pulse on the nanosecond scale, but, on the other hand, all pieces of spectroscopic information on the particle energy get lost. Ionization chambers well tolerate high radiation doses, but aging effects can limit their operational stability in long-term applications. Further disadvantages of ionization chambers are the laborious assembly in experimental setups involving gas regulation systems and high safety concerns. A third group of detection techniques involves scintillators constructed of materials that absorb high-energy radiation, such as α-, β-, γ-rays, X-rays, neutrons or other particles, and convert their energy into optical photons via utilizing activator impurities created by doping. In detectors for the above-mentioned radiations, said photons are then converted into electric pulses by suitable photodetectors, e.g. photomultipliers.

Scintillation detectors are used to detect ionizing radiation as part of detector systems, for example X-rays in computed tomography (CT) devices. The size and geometry of the scintillator is designed to meet requirements of practical use, for example to absorb X-rays or y photons with sufficiently high efficiency, which is necessary to acquire spectroscopic information with good proportionality and high resolution. Thus, thickness of the scintillation layer of such scintillators along the direction of the impinging X-rays or y photons is generally reasonably large, preferably falls into the mm range. In contrast, detection and energy measurement of charged particle radiations favours the use of scintillators with reduced dimensions, since their energy deposition mechanism is not of probabilistic nature, and charged particle radiations have a well-defined penetration depth in condensed matter. The thickness of thin-film scintillators can be optimized to fully absorb charged particles with minimal loss of emitted photons. Furthermore, since the stopping range of charged particles is short, typically falls into the range of 1-100 μm, and the energy deposition density is high, dopant concentration becomes a crucial parameter for scintillation yield and decay lifetimes. Dopants, for example cerium, form recombination traps for the charge carriers generated by the energy deposition process, whose mobility and the rate of recombination processes may also be crucial factors for the adequate operation of the scintillator. An alternative solution for charged particle detection has also been tested long ago, using dopant-free organic crystals, for example anthracene, which produce luminescence due to their conjugated molecular structure, and have a low density, a hallmark of typical organics, allowing longer penetration depth for particle beams. However, dopant-free organic crystals have major drawbacks, such as low scintillation yield and weak tolerance to environmental conditions. Dopant-free organics are mostly used in liquid form predominantly for neutron detection due to their high hydrogen content and volumetric scalability.

Dopant-free inorganic substances exhibiting luminescence primarily generate scintillation photons via self-trapped excitonic states, which are localized states confined by energy barriers due to the strong exciton-phonon coupling in such materials. However, the excitation mechanism of bright excitonic states is obviously initiated by electronic collisions of the decelerating charged particles, the subtle interplay of electron-ion interactions and recombination processes hamper the predictability and microscopic understanding of radioluminescence generated by charged particles. This is especially true during the last stage of the stopping process, i.e. in the Bragg region, where the energy loss density increases with the decreasing kinetic energy of the particles, because the nuclear component of stopping gradually surpasses that of the electronic component along the deceleration, which process eventually leads to high fluctuations of radiative and non-radiative decay probabilities on microscopic scale, and super-Poissonian photon statistics is expected. This effect is more pronounced for the stopping process of heavy ions and molecular ions, since the contribution of nuclear stopping component drastically increases with the ion mass and these species typically exhibit a wide distribution of their charge state. Based on this consideration, scintillators were previously not recommended for the detection of heavy ions and molecular ions, especially at low energies, more specifically below 1 MeV/amu [see e.g. the paper by Weber et al. (2015), DOI: 0.1016/j.cossms.2014.09.003]. Here, and from now on, the term ‘heavy ions’ refers to ions with a mass number (A) greater than that of α particles (that is, A>4).

Y. Morishita [see the paper by Morishita et al. (2014), DOI: 10.1016/j.nima.2014.07.046] has investigated α-particle detection characteristics with commercially available scintillator materials in thin-layer scintillators. The authors found that some expediently doped, specifically Ce-doped inorganic crystals with thicknesses of 100 μm and below exhibited the highest scintillation yield and the best energy resolution of all materials studied before. The authors claim that the outstanding luminescence of the scintillators considered could be attributed to their single-crystal structure due to the minimized loss in light transmission. The material composition, the involvement of doping, the layer structure and the spatial dimensions of the tested scintillator materials differ from the subject of the present invention as outlined below.

The effective detection of particle radiations of heavy ions, specifically of elements with a mass number greater than 50 (that is, A>50), and more specifically of fission products, by using scintillators is uncommon in practice due to the low luminosity generated by the scintillation process. For example, G. Rusev [see the paper by Rusev et al. (2015), DOI: 10.1117/12.2192440] has clearly demonstrated the limits of fission fragment detection by thin-film plastic scintillators which is the result of the extended overlap of light yield distributions of various particle species reaching said scintillators.

As far as suitable scintillator materials are concerned, it is well-known that lead-based halide compositions with perovskite structure can be used as scintillator materials. Chinese patent Appl. No. CN110734765A teaches preparation processes for the production of nanocrystalline powders of Cs₄PbBr₆ and CsPbBr₃ to be used in detecting nuclear radiation signals, Capability of spectroscopic detection is neither described nor hinted at for the obtained scintillator materials.

Furthermore, Chinese patent Appl. No. CN112442360A discloses a preparation process for the production of lead-free copper-based halide scintillator films to be used in the process of indirect X-ray detection. According to the preparation process, at first a copper-based halide crystal powder AₓCu_{y}X_{z} is prepared in an isopropanol-based medium with added hypophosphorous acid as reduction protective agent, and then spread on a first substrate; here, A represents a monovalent alkali metal cation, X represents a monovalent halogen anion, and x:y:z (positive integer numbers) satisfies one of the relations 1:2:3, 2:1:3, and 3:2:5. Preferably, the monovalent alkali metal cations include caesium ions, rubidium ions, and potassium ions. Preferably, the monovalent halogen anions include iodide, bromide and chloride ions. Then, to obtain a copper-based halide crystal powder melt, the first substrate is heated to a relatively high temperature, preferably to at least 360° C. Simultaneously, a second substrate is pre-heated, then laid on the copper-based halide crystal powder melt, and pressure is applied to the lead-free copper-based halide crystal powder melt through e.g. the second substrate. Then, the obtained sandwich structure is cooled down. After cooling, the first and second substrates are removed, thereby obtaining a self-standing copper-based halide scintillator film. To prepare the copper-based halide crystal AₓCu_{y}X_{z}, a mixture of an alkali metal halide AX and an alkali metal cuprous compound CuX is produced. Then, a hydrohalic acid HX and a reduction protection agent, preferably hypophosphorous acid, are added to the mixture, and to obtain a copper-based halide precursor solution, the thus obtained mixture is subjected to heating. Then, to precipitate the copper-based halide crystals AₓCu_{y}X_{z}, the precursor solution is cooled down. The obtained copper-based halide crystals AₓCu_{y}X_{z} might contain some reduction protective agent as well, that is, they are basically not of phase-pure composition. To purify the copper-based halide crystal powder AₓCu_{y}X_{z}, the precipitated copper-based halide crystals are washed with an organic solvent, that is, isopropanol, and then vacuum dried and ground. Preferably, the powder particle size of the obtained copper-based halide crystals is less than 5 microns, and the thickness of the obtained scintillator film is 10 microns to 1 mm. The lead-free copper-based halide scintillator crystals obtained by the above-referred preparation process have got the inherent advantages of high light yield, high response speed, and optimal spectral matching with photodetectors. The obtained scintillator film is applied in the field of X-ray detection due to its high detection efficiency, short resolution time, convenient use, and wide applicability. Furthermore, Chinese Patent Appl. Nos. CN111348675A, CN112048764A, and CN109943322A disclose similar scintillator films of the same composition and stoichiometry for exclusively X-ray detection applications.

That is, copper-halide compositions with perovskite-analogue structure are already known in the art as X-ray scintillator media. A number of studies was exclusively devoted to the characterization of X-ray induced radioluminescence in such scintillator media and the development of X-ray screens of given thickness in a typical range of 0.2-1.0 mm. However, due to the very different nature of the interactions of X-rays and charged particles with matter, in particular, regarding the amount of energy of the ionizing radiation to be absorbed and the penetrating depth thereof, copper-halide compositions have not been previously proposed as charged particle scintillator media.

Chinese Patent Appl. No. CN112456537A discloses a preparation method to produce a scintillator film of β-phase copper-based halide β-Cs₃Cu₂Cl₅. The β-Cs₃Cu₂Cl₅ scintillator medium has good crystallinity, the solid film has short attenuation lifetime, high photoluminescence quantum yield, and weak self-absorption effect. When used in X-ray detection, the scintillator made of β-Cs₃Cu₂Cl₅ obtains high photon yield, good linear response, and low detection limit. According to the preparation method, the synthesis of β-Cs₃Cu₂Cl₅ is performed from caesium oleate which is prepared in a previous step. To form the scintillator film, the β-Cs₃Cu₂Cl₅ dissolved in toluene is drop-casted on a glass or quartz substrate. The drop casting method used to form said film makes the thickness and size of the scintillator film controllable.

Traditionally, the preparation of metal-halide perovskite thin films is generally carried out from the mixture of dimethylformamide (DMF)/dimethyl sulfoxide (DMSO). These solvents have a high boiling point (above 150° C.), which either necessitates high-temperature processing or post-treatment of the perovskite layers to remove the solvent residues (anti-solvent treatment). Furthermore, DMF can be considered rather toxic.

X-ray induced radioluminescence of copper-halide perovskite-analogues is known (see above). For the time being, no example for charged particle induced radioluminescence has yet been demonstrated with this family of materials. The reason for this is found in the fact there is a fundamental difference between X-ray and charged particle detection as regards both scientific and technological goals. X-rays are utilized for material characterization and visualization. To this end, in particular, to obtain appropriate image contrast and thus improve signal-to-noise ratio in the study, a relatively high and continuous radiation flux, as well as calorimetric detection methods are required. For X-ray detection, most frequently a CCD-based light integrating device is made use of. Studies on X-ray induced radioluminescence reported record values for the sensitivity as ˜30 nGy/s for CH₃NH₃PbBr₃ single crystals, and even higher values for perovskite-analogues e.g. ˜120 nGy/s for Rb₂CuBr₃ [see e.g. B. Yang (2019) doi: 10.1002/adma.201904711]. That is, X-ray flux below these limits cannot yield sufficient image contrast.

In contrast to X-ray detection with scintillation screens, charged particle detection focuses on the identification of individual charged-particle incidences, involving observables related to both the particle type and kinetic energy. That is, for charged particle detection, individual radiation components are of importance. This also requires specific instrumentation different from that of continuous-flux X-ray detection, for example charge-collection devices or photomultipliers that provide sufficient signal-to-noise ratio. Accordingly, to improve the signal-to-noise ratio and detection efficiency, principally different strategies shall be applied for X-ray and charged particle radiations.

In particular, the interaction of X-rays with matter, such as layers of scintillator substances, is of probabilistic nature. Therefore, scintillation yield scales with the radiation flux and/or the layer thickness. The energy deposition mechanism is purely electronic, typically photoelectric effect is the dominating excitation channel. The generated core-hole states evolve through a well-described de-excitation route, eventually populating excitons, which are frequently bright radiative states in perovskites. A definite part of the excitation energy, which is taken by the escaping fluorescent X-rays, is lost, and cannot contribute to the scintillation yield. In contrast, the energy deposition mechanism of charged-particle beams comprises less definite components due to nuclear recoil losses, which is a sensitive function of several parameters, such as the charge state of ionic species of the beam and the atomic mass composition of the stopping material. The magnitude of the recoil loss and its uncertainty steeply increases with particle mass, as already discussed earlier.

It is a well-established prediction that individual charged-particle incidences cannot be identified nor characterized with voltage pulse discrimination, specifically for charged particles with E/A<1 MeV/amu, more specifically for heavy ions with A>4 amu. The voltage pulse discrimination may refer to any of time-to-digital (TDC), amplitude-to-digital, or charge-to-digital (QDC) conversions. These techniques are effective under given circumstances but might fail to discriminate separate charged-particle incidence events in two cases. Firstly, when the rate of charged-particle radiation is far lower than the rates of dark noise or environmental background radiations in the photodetector. Secondly, when the decay constant of the radioluminescence pulse is large enough to stretch the pulse waveform in time and split up its structure to single-photon peaks. From practical point of view, the precision and confidence of timing and spectral observables of charged-particle detection can be enhanced by the appropriate choice of the scintillation material and a pulse detection technique recording the temporal structure of the entire scintillation light.

Charged-particle emission is mostly accompanied by radiation components of both nuclear and electronic origin, such as γ radiation or secondary electrons. In the field of investigating complex nuclear processes, measurement setups are typically designed to record fast electric pulses from the detectors either for time-of-flight measurements or verification of the casual relationship between different detector signals. Nuclear and high-energy hadronic processes usually suffer from the statistical uncertainties of random coincidences, especially at high-rates of disturbing radiation background. The detection of reaction products with improved timing precision and simultaneous spectroscopic information on the kinetic energy increases the confidence of the identification of correlated events, and also supports high data flow for the data acquisition.

Scintillator units composed of subunits of copper-halide perovskite-analogues with different compositions and stoichiometry enable the characterization of the charged-particle beam with a new set of parameters. In a simple example, a sandwiched bilayer of Cs₃Cu₂Br₅/Cs₃Cu₂I₅ has been tested. The difference in radioluminescence time constants of the two compositions is exploited to separate light sources and to measure the ratio of their contributions in the scintillation waveform. This technique has been evidenced to be capable of determining the incident angle and the kinetic energy of individual charged particles.

In light of this, the main object of the invention is to provide a scintillator unit for charged-particle detection with high significance of particle identification, good timing resolution, and the capability of providing spectroscopic information on the kinetic energy of the said charged particles.

A further object of the invention is to elaborate improved preparation processes for the economical production of said scintillator unit to be used for charged-particle detection.

In particular, an object of the present invention is to work out such production processes to prepare scintillation units to be used for charged-particle detection wherein the application of high temperatures, that is temperatures above 200° C., preferentially above 175° C., and more preferably above 150° C. is not required. A yet further object of the present invention is to work our such production processes to prepare scintillation units to be used for charged-particle detection wherein there is basically no need for handling phase-mixed compositions and thus complicated or time-consuming purifying steps.

A further object of the invention is to improve charged particle detection devices used nowadays as to the above-referred existing needs. Additional objects, as well as aspects, features and advantages, of the present invention will be set forth in the following description.

### SUMMARY OF THE INVENTION

We found in our extensive studies that dopant-free copper-based inorganic thin-film scintillators can be used to detect charged particles, if the film thickness of the applied scintillation substance is appropriately selected, i.e. it is greater than the stopping range of the charged particle to be detected in the scintillation substance. The charged particles are selected from the group consisting of electrons, protons, alpha particles, and heavy ions, i.e. ionic species of chemical elements of the Periodic Table of Elements and ionic species of molecules, as well as fission fragments, all with the unified atomic mass unit of at most 150. The presented scintillation substances enable the significant identification and characterization of individual charged particles.

The useful luminescent substance family adopts the general stoichiometry of either AₓB₃₋ₓCu₂X_{y}Y_{5-y} with 0≤x≤3, 0≤y≤5 or AₓB₁₋ₓCu₂X_{y}Y_{3-y} with 0≤x≤1, 0≤y≤3, wherein any of A and B is a monovalent alkali metal cation, and any of X and Y is a monovalent halogen element anion or a pseudohalide. Here, any of A and B is selected from a group consisting of caesium (Cs) and rubidium (Rb), and any of X and Y is selected from a group consisting of chlorine (Cl), bromine (Br) and iodine (I), the pseudohalide is either cyanide (CN) or thiocyanide (SCN). These substances are derived from the prototypical hybrid organic-inorganic ABX₃ perovskite structure and can be considered as perovskite-analogue materials. The crystal lattice comprises of inorganic cations, that are non-toxic and also makes them more tolerant towards environmental factors (e.g., moisture, oxygen) compared to their organic cation containing counterparts.

These substances further possess a large Stokes-shift which is the result of the presence of self-trapped excitons in these substances. This is beneficial for light emitting applications as the emitted light will not be reabsorbed by the substance itself (unlike in the classic ABX₃-type metal-halide perovskites).

In one aspect of the present invention, dopant-free copper-based inorganic layers of said luminescent substances are arranged, preferably deposited as μm-scaled layers by various preparation techniques on a surface of a transparent substrate, made of e.g. glass, fluorine-doped tin oxide coated glass, quartz, plastics, such as polyethylene, wherein said substrates are transparent at least in the wavelength range of the luminescent peak of the luminescent substances. Thereby, scintillation units are obtained which are capable of converting the kinetic energy of charged particles to photons and transmitting to optically connected photon detectors, for example a photomultiplier tube or a silicon-based photomultiplier. The electric pulses at the anode of the photomultiplier detector are measured with a high sampling-frequency voltage digitizer scanning the entire range thereof. The incident charged particles deposit at least a part or their total kinetic energy, depending on the ratio of their stopping range in the substance used in the scintillation unit and the film-thickness of the substance in the scintillation unit.

In a further aspect of the present invention, preparation processes for said luminescent substances are provided. A major point of the preparation processes is that a mixture of acetonitrile/water, as solvent, is used to prepare a precursor solution for the perovskite-analogue inorganic luminescent substances. To prepare the precursor solution first a precursor compound of a general chemical formula AX (or BX in mixed cation compositions) and a second precursor compound of a general chemical formula of CuX (or CuY in mixed anion compositions) are dissolved in the desired stoichiometric ratio in the solvent. Here, both precursor compounds can also be a mixture of two precursor compounds to prepare mixed cation and/or anion variants. In the case of a mixed anion luminescent substance, with a general formula of ACu₂X_{y}Y_{3-y} the use of AX, AY, CuX and CuY precursor mixture is used in the desired stoichiometric composition (this is also applicable for the A₃Cu₂X_{y}Y_{5-y} composition). In preparing an AₓB₁₋ₓCu₂X₃ mixed cation luminescent substance, the use of AX, BX and CuX precursors are used in the desired stoichiometric composition (also applicable for the AₓB₃₋ₓCu₂X₅). Here, in these examples A and B stand for Rb, Cs, and X and Y stand for Cl, Br, I, or different pseudohalides (e.g. CN, SCN). The copper-based precursor compounds are highly soluble in acetonitrile. In stark contrast, the other precursor compounds (AX and BX) are insoluble in acetonitrile. However, the latter have a high solubility in water. Thus, the acetonitrile/water mixture solvent is capable of dissolving both precursor compounds, while it possesses a lower boiling point and is less toxic. With this preparation strategy, the luminescent substances of either AₓB₃₋ₓCu₂X_{y}Y_{5-y} with 0≤x≤3, 0≤y≤5 or AₓB₁₋ₓCu₂X_{y}Y_{3-y} with 0≤x≤1, 0≤y≤3 can be obtained as thin films (e.g. by spray coating), and powders (evaporation under mild conditions). The use of this solvent mixture to dissolve the precursors and the ability to prepare the desired material compositions by tuning the precursor concentrations is not obvious to the skilled artisans, as production methods involving complex formation, in general, is a complicated chemical process.

Polycrystalline inorganic materials, like the perovskite-analogue luminescent substances taught in the present disclosure generate scintillation, which exhibit competitive scintillation yield with that of highly expensive, activator-doped single-crystal scintillator materials. According to our understanding, this finding of perovskite-analogues is attributed to their surprisingly large Stokes shift preventing self-absorption of luminescence emission, which minimizes light transmission losses. This allows the use of cost-effective thin films instead of expensive single crystals. Moreover, dopant-free copper-based inorganic perovskite-analogues inherently possess good light transmission facilitated by layer transparency compared to single-crystals, since the luminescence emission is mediated by self-trapped excitons instead of activator impurities.

Thin-film scintillators may offer an intermediate solution for charged particle detection amongst traditionally used semiconductor-based charge collection devices, single crystal-based bulk scintillators and organic-based scintillators via offering a combination of fast timing signals and spectroscopic measurement, as well as far more simple operational conditions. The advantage of employing perovskite-analogues as thin-film scintillators arises when compositional mixing is exploited for tuning the time structure of luminescence. Moreover, complex architectures, such as heterogeneous multilayers, can be employed to obtain information on the position or angle of flight paths of charged particles by evaluating the scintillation waveforms.

In particular, the above objects are achieved by a charged-particle scintillation unit according to claim 1. Further preferred embodiments of the charged-particle scintillation unit are set forth in claims 2 to 8. In case of the scintillation unit comprising the luminescent substance with the general chemical formula of AₓB₃₋ₓCu₂X_{y}Y_{5-y}, the scope of protection defined by the appended set of claims for the scintillation unit itself does not extend to a scintillation unit comprising the luminescent substance with the specific choice of x=3 and y=5.

The above objects are achieved by a use of a charged-particle scintillation unit comprising a perovskite-analogue luminescent substance in accordance with claim 9. Preferred variants of the use are set forth in claims 10 to 16.

Moreover, the above objects are achieved by a process to prepare a charged-particle scintillation unit in accordance with claim 17. Preferred further variants of the preparation process are defined by claims 18 to 29.

And finally, the above objects are achieved by a charged particle detection device according to claim 30. Preferred further embodiments of the charged particle detection device are set forth in claims 31 to 32.

As it will also be apparent from the following description and the examples discussed in detail, the dopant-free copper-based perovskite-analogue inorganic thin-film scintillator for charged-particle detection according to the present disclosure simultaneously meets the requirements of fast timing, high detection efficiency, high selectivity for charged particles, cost-effectiveness, flexibility regarding the preparation processes, and high durability in harsh environments. Furthermore, the dopant-free copper-based inorganic thin-film scintillator is capable of acquiring spectroscopic and timing information of charged particles in a wide range of particle mass and kinetic energy, for example electrons and heavy ions, which also offers a novel solution for fission fragment detection and separation.

### BRIEF DESCRIPTION OF THE DRAWINGS

In what follows, the invention is described in detail with reference to the accompanying drawings, wherein

FIGS. 1A and 1B illustrate the unit cell of a dopant-free copper-based perovskite-analogue luminescent substance of the general formula AₓB₃₋ₓCu₂Y_{y}X_{5-y} with x=3, y=0, that is A₃Cu₂X₅, and AₓB₁₋ₓCu₂Y_{y}X_{3-y} with x=1, y=0, that is ACu₂X₃, respectively;

FIG. 2 shows in plots A and B top-down scanning electron microscopic (SEM) images of a spray-coated CsCu₂I₃ film and a spray-coated Cs₃Cu₂I₅ film, respectively;

FIGS. 3A and 3B show the X-ray diffraction patterns of the scintillation films of FIG. 2;

FIGS. 4A and 4B show the X-ray diffraction patterns of a CsCu₂Br₃ film and a Cs₃Cu₂Br₅ film, respectively, obtained with changing the precursor solution compositions as to the X-site chemical element from iodine to bromine;

FIG. 5 illustrates the X-ray diffraction pattern of spray-coated RbCu₂Br₃ films prepared at various spray coating temperatures (see plots (b) to (d)) together with the simulated reference pattern for RbCu₂Br₃;

FIGS. 6A and 6B show the X-ray diffraction patterns of the powdery substances CsCu₂I₃ and Cs₃Cu₂I₅, respectively, for scintillation films prepared by evaporation technique;

FIGS. 7A and 7B show the X-ray diffraction patterns of the powdery substance CsCu₂Br₃ and the powdery substance Cs₃Cu₂Br₅, respectively, obtained with changing the precursor solution compositions as to the X-site chemical element from iodine to bromine;

FIG. 8 shows the X-ray diffraction pattern of a CsCu₂I₃ scintillation film prepared from a viscous paste containing powdery luminescent substance by the doctor blade technique;

FIG. 9 presents the compositional characteristics of spray-coated CsCu₂I₃ scintillation films (plots A to C) and spray-coated Cs₃Cu₂I₅ scintillation films (plots D to F);

FIGS. 10A and 10B illustrate the UV-visible absorption and the photoluminescence spectra together of an exemplified spray-coated CsCu₂I₃ scintillation film with a film-thickness of 0.9 μm and a further exemplified spray-coated Cs₃Cu₂I₅ scintillation film with a film-thickness of 1.2 μm, respectively;

FIGS. 11A and 11B present the steady-state photoluminescence of an exemplified spray-coated Cs₃Cu₂Br₅ scintillation film and a further exemplified spray-coated RbCu₂Br₃ scintillation film, respectively;

FIGS. 12A and 12B illustrate the results of photoluminescence (PL) decay measurements of CsCu₂I₃ scintillation films, on glass, at 570 nm and Cs₃Cu₂I₅ scintillation films, also on glass, at 440 nm, respectively;

FIGS. 13A and 13B show the results of photoluminescence (PL) decay measurements of Cs₃Cu₂Br₅ scintillation films, on glass, at 450 nm and RbCu₂Br₃ scintillation films, also on glass, at 400 nm, respectively;

FIG. 14 shows some examples of typical pulse waveforms recorded for Cs₃Cu₂I₅ (plot a) and CsCu₂I₃ (plot b) films and a 3-mm thick doped CsI(Tl) scintillator for comparison (plot c);

FIG. 15 shows the zoomed rising-edge region of the pulse waveforms recorded for Cs₃Cu₂I₅ (plot a) and CsCu₂I₃ (plot b) compositions, a 3-mm thick doped CsI(Tl) scintillator (plot c), and a 10-mm thick plastic scintillator (UPS89; plot d) for comparison;

FIGS. 16A, 16B, and 16C show the statistical distributions of scintillation yields, the 1/e decay time constants for the fast and slow components of the applied biexponential fit, respectively, for various compositions of the scintillator film. The decay time fit was applied on the statistical average of the corresponding pulse waveforms. The starred group in FIG. 16B represents the corresponding curves of CsCu₂Br₃ (dashed), RbCu₂I₃ (dotted), and RbCu₂Br₃ (dashed-dotted). The starred group in FIG. 16C represents the corresponding curves of CsCu₂I₃ (solid), CsCu₂Br₃ (dashed), RbCu₂I₃ (dotted), and RbCu₂Br₃ (dashed-dotted).

FIGS. 17A and 17B present the statistical distributions of scintillation yields obtained from Cs₃Cu₂I₅ and CsCu₂I₃ films, respectively, for various film thicknesses;

FIGS. 18A and 18B present the statistical distributions of scintillation yields obtained from Cs₃Cu₂I₅ and CsCu₂I₃ films, respectively, excited by different charged-particle types;

FIG. 19 shows the linear behaviour of mean scintillation yield as a function of incident particle energy for Cs₃Cu₂I₅ and CsCu₂I₃ films for a particles;

FIG. 20 shows the energy resolving power of mean scintillation yield as a function of incident particle energy of a particles for Cs₃Cu₂I₅ and CsCu₂I₃ films, a 3-mm thick doped CsI(Tl) scintillator, and a 10-mm thick plastic scintillator (UPS89) for comparison;

FIGS. 21A and 21B show possible embodiments of single-arm measurement setups for charged particle detection comprising the scintillation unit prepared with using a dopant-free copper-based perovskite-analogue inorganic luminescent substance according to the invention;

FIG. 22 illustrates a possible embodiment of a double-arm measurement setup for charged particle detection comprising the scintillation unit prepared with using a dopant-free copper-based perovskite-analogue inorganic luminescent substance according to the invention, the setup is used preferentially to coincidence measurements;

FIG. 23 is a correlation plot and its projections for fission fragments detected with two scintillation units according to the present invention made of Cs₃Cu₂I₅ layers in time-coincidence mode;

FIG. 24 shows the scintillation yields of thirty scintillation pulses recorded for a Cs₃Cu₂I₅ thin-film obtained according to the present invention and a CsI(Tl) bulk scintillator under identical measurement conditions with the scintillation yield being approximated with a mono-exponential decay curve in both cases;

FIG. 25 illustrates the averaged scintillation waveforms for various Cs₃Cu₂X₅ (X=Br, I) thin-films obtained according to the present invention, wherein the symbols (1), (2), (3), and (4) correspond to thin-films with the compositions of Cs₃Cu₂I₅, Cs₃Cu₂Br_{1.25}I_{3.75}, Cs₃Cu₂Br_{2.5}I_{2.5} and Cs₃Cu₂Br_{3.75}I_{1.25}, respectively; and

FIG. 26 shows a comparison of scintillation light yields for a traditional CsI(Tl) bulk crystal and the Cs₃Cu₂I₅ thin-film obtained according to the invention for scintillation pulses induced with a mixed alpha source composed of alpha emitter isotopes appropriate for checking energy resolving power and energy calibration of scintillators.

### DESCRIPTION OF POSSIBLE EMBODIMENTS

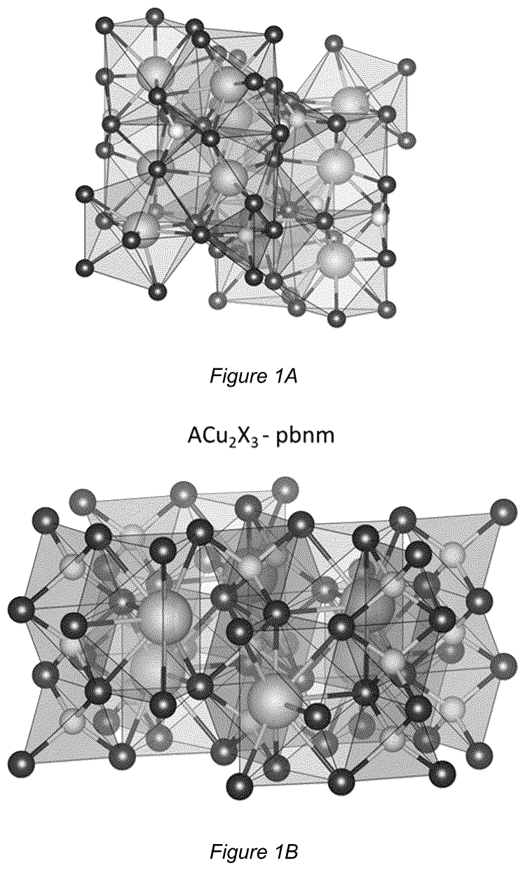

FIG. 1A illustrates the unit cell of a representative dopant-free copper-based perovskite-analogue inorganic luminescent substance A₃Cu₂X₅ (of the general formula AₓB₃₋ₓCu₂Y_{y}X_{5-y} with x=3, y=0) used to prepare the inventive scintillation unit to detect charged particles according to the present invention. The unit cell is of cmcm symmetry. Here, A represents a monovalent alkali metal cation, such as e.g. Cs⁺, Rb⁺, or a mixture of Cs⁺ and Rb⁺, and X represents a monovalent halogen element anion, such as e.g. Cl⁻, Br⁻, I⁻ or a mixture of Cl⁻, Br⁻, I⁻, or a pseudohalide, such as e.g. CN, or SCN.

FIG. 1B illustrates the unit cell of a further representative dopant-free copper-based perovskite-analogue inorganic luminescent substance ACu₂X₃ (of the general formula AₓB₁₋ₓCu₂Y_{y}X_{3-y} with x=1, y=0) used to prepare the inventive scintillation unit to detect charged particles according to the present invention. The unit cell is of pbnm symmetry. Here, A represents a monovalent alkali metal cation, such as e.g. Cs⁺, Rb⁺, or a mixture of Cs⁺ and Rb⁺, and X represents a monovalent halogen element anion, such as e.g. Cl⁻, Br⁻, I⁻ or a mixture of Cl⁻, Br⁻, I⁻, or a pseudohalide, such as e.g. CN, or SCN.

In what follows, some improved preparation processes are discussed in detail by means of which the dopant-free copper-based perovskite-analogue inorganic luminescent substances illustrated in FIGS. 1A and 1B are produced.

Method A: Spray Coating onto a Preheated Substrate

In this preparation process, a substrate is pre-heated to a temperature in the range of 50-150° C. by means of direct heat transfer from a heated hotplate, on the hot surface of which the substrate is arranged before commencing with a thin-film scintillator unit preparation. As the substrate, to mention here a few examples only, a glass plate, a fluorine-doped tin oxide (FTO) coated glass plate, a flexible polyethylene (PET) sheet can equally be used. To prepare said thin-film scintillator unit, a precursor solution composition with the chemical components of the luminescent substance with desired stoichiometry is spray coated onto a surface of the pre-heated substrate at a given spray coating rate in the range of 0.05-5 cycles/second, preferably 0.05-0.2 cycles/second, and most preferably at 0.1 cycles/second. To obtain said precursor solution composition, a first precursor compound AX and a second precursor compound CuX (where A: Rb, Cs, and X: Cl, Br, I) are dissolved in a stoichiometric ratio, preferably at room temperature, in a solvent formed by mixing together previously acetonitrile and water. By controlling the precursor solution composition, phase pure compounds (e.g., A₃Cu₂X₅ or ACu₂X₃) and mixed compositions can also be prepared (e.g., AₓB₃₋ₓCu₂X₅ and A_{y}B_{1-y}Cu₂X₃ (0≤x≤3; 0≤y≤1) or A₃Cu₂XₓY₅₋ₓ and ACu₂X_{y}Y_{3-y} (0≤x≤5; 0≤y≤3)).

Said spray coating of the precursor solution composition is performed in subsequent turns by a suitable airbrush gun, known by the skilled artisan. The number of cycles applied here depends on the final film-thickness of the luminescent substance, i.e. the thin-film scintillator, to be achieved. That is, by controlling the number of cycles of the spray coating, the film-thickness of the deposited substance layer is controlled within the range of 1-100 μm. In this range, any film-thickness can be achieved by spray coating.

Preferably, by changing at least one of the precursor compositions either A to B in the first precursor compound or X to Y in the second precursor compound between two consecutive turns of said spray coating, a scintillation unit comprising a luminescent substance of varying mixed composition can be obtained. This way, a scintillation unit with a thin-film of luminescent substance formed of layers with a composition gradient can also be prepared.

The advantage of method A lies in its simplicity and the choice of non-hazardous solvents, i.e. acetonitrile and water. Furthermore, no substrates of high melting point are required. Moreover, no additional annealing step is required to obtain the desired crystallographic phases (i.e. perovskite structure).

### Method B: Evaporation of a Solvent Mixture

As a first step, the precursor mixture discussed in relation to method A is prepared by dissolving precursors AX and CuX (where A: Rb, Cs, and X: Cl, Br, I) in a mixture of acetonitrile/water in a stoichiometric ratio. Then, by evaporating the acetonitrile/water solvent mixture containing the precursors AX and CuX in a stoichiometric ratio on a heated hotplate at the temperature of about 120° C. (which is the temperature of the surface of the heated hotplate), a powdery substance is obtained. In a subsequent step, optionally, said powdery substance is washed with cold (i.e. room temperature) ethanol, and then, if needed, the obtained solid material is (fine-) ground. The thin-film scintillator unit is then prepared from the thus obtained ethanol-washed and ground powdery substance by means of arranging and mounting said powdery substance on the surface of a suitable substrate (see method A).

The advantage of method B lies in its simplicity and the choice of non-hazardous solvents, i.e., acetonitrile and water. Furthermore, no substrates of high melting point are required. Also, large quantity of the scintillator compounds can be readily prepared.

### Method C: Layer Preparation by Doctor Blade Technique

From the powdery substance obtained in method B, a viscous paste is prepared. To this end, the solid material obtained by ethanol washing is (fine-) ground together with an organic solvent. Here, 1-nonanol is used as the organic solvent, however, it is apparent to the skilled artisan that many other suitable organic solvents can also be used. The composition of the obtained paste as regards its powdery substance content varies between 15-70 m/m %, preferably 30-65 m/m %, most preferably 40-60 m/m %. The obtained viscous paste is then used to form a layer on the substrate by a doctor blade, preferably in a single turn, by spreading the paste applied on the surface of the substrate by moving the blade evenly over said surface. To remove the organic moieties and obtain a final free-standing scintillator film, the layer formed on the substrate is then placed on the heated hotplate at the temperature of about 120° C. and annealed for about 10 minutes. The final film-thickness of the scintillator layer is controlled by setting the striking-off distance of the blade relative to the surface of the substrate, also taking into account the decrease in said thickness (i.e., shrinkage) that takes place during annealing. The amount of said decrease can be determined experimentally, e.g. in previous calibration steps, in a manner known by the skilled artisan.

The advantage of method C lies in its simplicity and the choice of non-hazardous solvents, i.e. acetonitrile, water and 1-nonanol. Furthermore, no substrates of high melting point are required.

The above-discussed preparation methods are used to prepare thin-film scintillation units from dopant-free copper-based perovskite-analogue inorganic substances on suitable substrates. In what follows, the application of the thus obtained scintillation units in charged particle detection devices is exemplified in some measurement configurations.

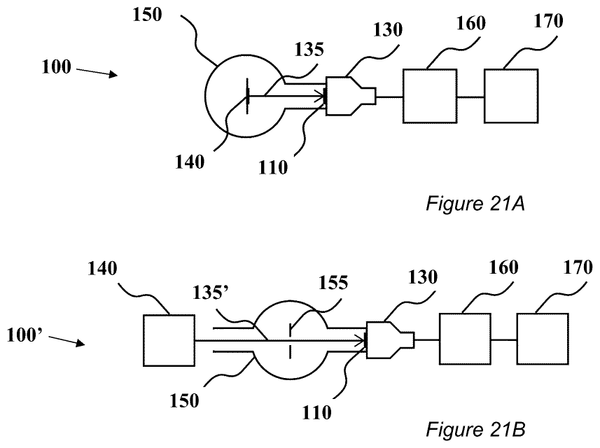

In particular, FIGS. 21A and 21B show schematically measurement setups 100, 100′ built with the dopant-free copper-based perovskite-analogue inorganic scintillation units according to the present invention to investigate particle radiation emitted by various radiation sources, i.e. a radioactive radiation source and a particle accelerator, respectively. Here, the dopant-free copper-based perovskite-analogue inorganic layers are used as scintillators in source-target arrangements as part of the charged particle detection devices applied.

To probe the scintillation units according to the present invention, in a first embodiment of the measurement setup 100, a scintillation unit 110 prepared as discussed above with a scintillation layer of e.g. Cs₃Cu₂I₅ or CsCu₂I₃ formed with e.g. a thickness of 40 micrometers on e.g. a glass substrate is arranged in optical coupling with a detector 130, preferably a photomultiplier tube (specifically, the type of ET Enterprises 9813B; however, any other types of photomultiplier tube can equally be used). As the detector 130, a silicon-based photomultiplier or a hybrid photomultiplier (that is, a photon detector) can also be used. As is known by the skilled artisan, the detector 130 is configured to measure scintillation events created within said scintillation unit 110 in response to an incoming charged particle 135 emitted by a radiation source 140. In the measurement setup 100 illustrated in FIG. 21A, the radiation source 140 is a radioactive radiation source, for example an Am-241 or Tc-99 source emitting α- or β-particles, respectively, as the charged particles 135, mounted either in a vacuum chamber 150 or under atmospheric conditions. The detector 130 is electrically connected with a suitable signal digitizing unit 160 configured to digitize electric signals outputted by the detector 130, wherein the signal digitizing unit 160 is electrically connected with a data acquisition unit 170, provided here in the form of e.g. a computer with suitable hardware and software elements known by the skilled artisan. Said data acquisition unit 170 records and processes, as desired, the digitized electric signals received from the signal digitizing unit 160. In a further preferred embodiment of a measurement setup 100′, shown in FIG. 21B, the radiation source 140 is an accelerator, for example a linear accelerator or a cyclotron, which delivers protons as the charged particles 135′ to the scintillator unit 110 through a further optional beam guiding system 155, for example suitably arranged collimators known by the skilled artisan.

Many processes, especially nuclear and high-energy reactions, terminate in more than one exit channels, typically emitting a variety of particles and electromagnetic waves. The confidence of particle identification and the precision of spectroscopic information rely on the measurement of timing correlations in experimental arrangements of two or more charged particle detection devices.

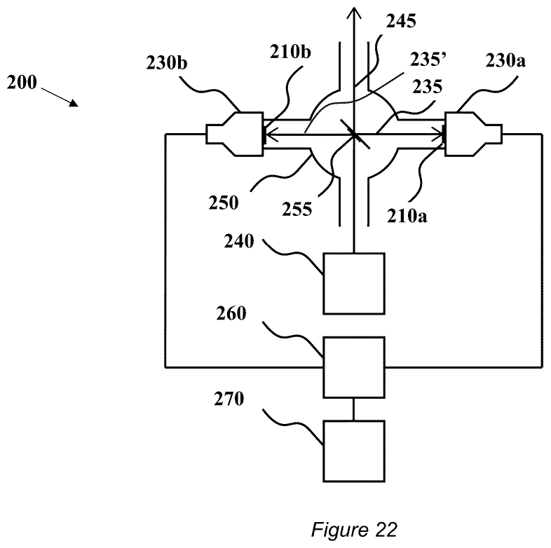

FIG. 22 illustrates schematically a further measurement setup 200 to probe the dopant-free copper-based perovskite-analogue inorganic scintillator units according to the present invention as coincidence measurement devices to be used, as an example, for investigating multichannel processes, that is, coincidental emission events.

To this end, in a yet further embodiment of a measurement setup 200, two scintillation units 210a, 210b are arranged around a spatial position, in which a radiation source 255 is located. Preferably, the two scintillation units 210a, 210b are located in a collinear geometry at 180° relative to each other, that is, at opposite sides of the radiation source 255, however, this is not required. Each scintillation unit 210a, 210b is prepared as discussed above with a scintillation layer of e.g. Cs₃Cu₂I₅ or CsCu₂I₅ formed with e.g. a thickness of 40 micrometers on e.g. a glass substrate and arranged at about 10 cm from said radiation source 255 in optical coupling with a respective detector 230a, 230b, preferably a photomultiplier tube (specifically, the type of ET Enterprises 9813B; however, any other types of photomultiplier tube can equally be used, too). As the detectors 230a, 230b, silicon-based photomultipliers or hybrid photomultipliers (that is, photon detectors) can also be used. Again, the detectors 230a, 230b are configured to measure scintillation events created within the scintillation units 210a, 210b in response to incoming charged particles 235, 235′ emitted by a radiation source 255. Here, the radiation source 255 can be a fissile target material comprising e.g. U-235 nuclei excited, i.e. bombarded, by an ion beam 245, e.g. a beam of protons having the energy to induce fission in the target nuclei, emitted by an accelerator 240. Thus, the charged particles 235, 235′ to be detected as emission events are fission fragments in this case. Again, said radiation source 255 is mounted either in a vacuum chamber 250 or under atmospheric conditions. Each detector 230a, 230b is electrically connected with a suitable signal digitizing unit 260 in a coincidence circuit. The signal digitizing unit 260 is configured to digitize the electric signals related to simultaneous fission events and outputted by the detectors 230a, 230b. Furthermore, the signal digitizing unit 260 is electrically connected with a data acquisition unit 270, provided here in the form of e.g. a computer with suitable hardware and software elements known by the skilled artisan. Said data acquisition unit 270 records and processes, as desired, the digitized electric signals received from the signal digitizing unit 260.

To perform a coincidence measurement, the pulse shapes of both detectors 230a, 230b are recorded for all emission events when any of the detectors 230a, 230b delivers a trigger signal by a common signal detection electronics of the signal digitizing unit 260. Then, the threshold crossing of pulse records are time-correlated in the data analysis (in a manner known by the skilled artisan) performed preferably by the data acquisition unit 270. The casual relationship of the signals is validated by setting limits for deviations with respect to zero time difference as is the standard practice in the field. This procedure enables the confident elimination of accidental coincidence pulses.

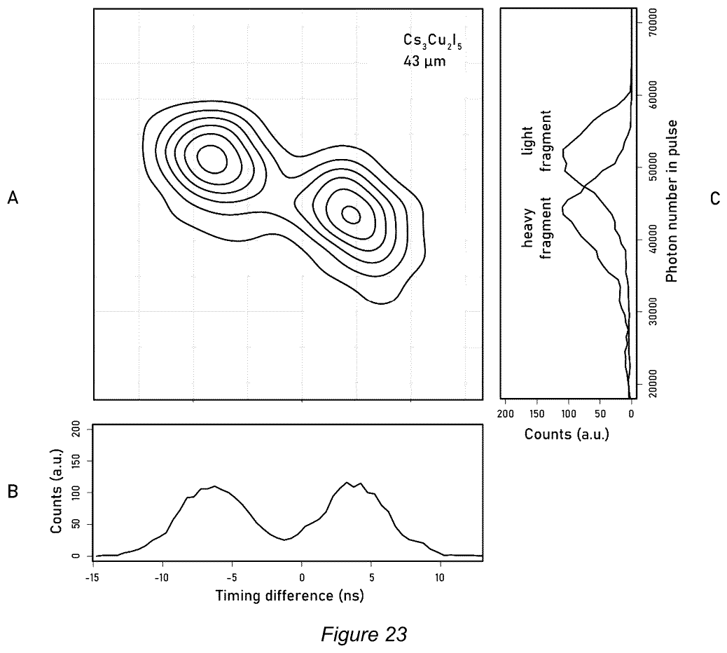

As an example for time coincidence measurements, FIG. 23 shows a correlation plot and its projections for fission fragments detected with two scintillation units having dopant-free copper-based perovskite-analogue inorganic layers according to the present invention, for example Cs₃Cu₂Is, in a composite detector arrangement, for example in a double-arm arrangement for coincidence measurement of simultaneous particle emissions in time-coincidence mode. Fission fragments originated from a target containing U-235 nuclei bombarded with a 12 MeV proton beam from a cyclotron.

The sensitivity of the applied dopant-free copper-based perovskite-analogue inorganic layers to heavy ion radiation is also tested in this experiment by measuring said fission fragments. The broad mass distribution of fission fragments exhibits two well-separated groups peaking around A=95 and 140 amu, which accomplishes the test of heavy ion radiation in a kinetic energy range of 50-100 MeV. The discrimination of fission fragments from other particle types, for example scattered beam particles or delta electrons, is based on the coincidence data by capturing both fission fragments. Pulse digitization is triggered by threshold crossing of any of the two photomultiplier signals, which are both recorded with the same time stamp. The event records are sorted by the coincidence condition of acquiring two validated pulses. The doublet structure of fission fragment mass distribution shown in plot A is observed in the timing difference of the threshold crossing as exemplified in plot B for e.g. scintillation units containing Cs₃Cu₂I₅ layers. The level of separation depends on the flight distance and the timing accuracy of the pulse leading edges. The scintillation yield of said Cs₃Cu₂I₅ scintillation unit shows an apparent correlation with the observed timing distribution, which is exploited for the identification of contributions of fragment groups, as is apparent from plot C.

This measurement also demonstrates that the dopant-free copper-based perovskite-analogue inorganic substances according to the present invention are suitable candidates for detecting heavy ions, especially fission fragments, by simultaneously measuring the heavy ions' timing information with high precision and the heavy ions' kinetic energy with moderate precision. Moreover, the identification of ionic species can be of high confidence even in a harsh radiation background of scattered beam particles, neutrons or delta electrons. Thus, assemblies of perovskite-analogue thin layers and photomultiplier detectors are believed to be unique tools for charged particle detection, especially for heavy ion detection, in the sense of introducing dopant-free copper-based and/or polycrystalline inorganic materials.

In what follows, some further aspects of the dopant-free copper-based perovskite-analogue inorganic thin-film scintillators for charged particle detection according to the invention is discussed in more detail through some examples based on experiments with various exemplified thin-film scintillators obtained by any of the methods A to C discussed above.

### Example 1

### (A) Morphological Characterization of Scintillation Films Obtained by Method A

In this example, morphological properties of some exemplified scintillation films prepared by method A are discussed in more detail.

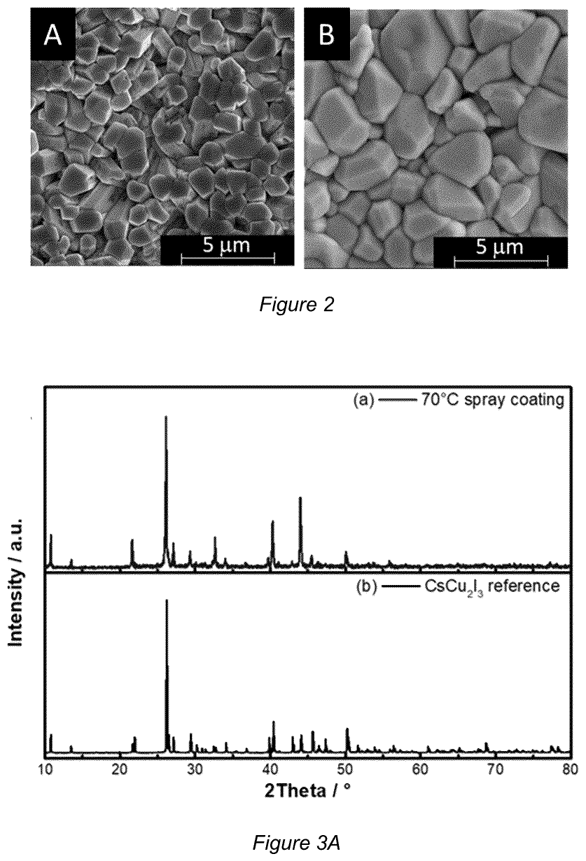

FIG. 2 shows in plots A and B the top-down scanning electron microscopic (SEM) images of a CsCu₂I₃ film and a Cs₃Cu₂I₅ film, respectively, both prepared by the spray coating technique of method A. To prepare the CsCu₂I₃ film, an acetonitrile-based solution containing 7.5 V/V % water at a temperature of 70° C. is used. To prepare the Cs₃Cu₂I₅ film, an acetonitrile-based solution containing 5.5 V/V % water at a temperature of 60° C. is used.

As can be seen in FIG. 2, granular polycrystalline (i.e., not single crystal) films are formed in the case of both substances. The grain size is 1.2±0.3 μm for CsCu₂I₃ films, and 2.8±1.0 μm for Cs₃Cu₂I₅ films.

As discussed above, with preparation method A the thickness of the films can be well controlled by altering the number of cycles of spray coating. The calculated thickness (from loading) and the measured film-thickness (from cross sectional SEM) are in good agreement with each other (for CsCu₂I₃ films, nominal film-thickness: 3.4±0.2 μm, actual film-thickness: 3.0±0.5 μm; for Cs₃Cu₂I₅ films, nominal film-thickness: 4.0±0.3 μm, actual film-thickness: 2.6±0.3 μm).

### (B) Crystallographic Characterization of Scintillation Films Obtained by Method A

In this example, crystallographic properties of some exemplified scintillation films are discussed in more detail.

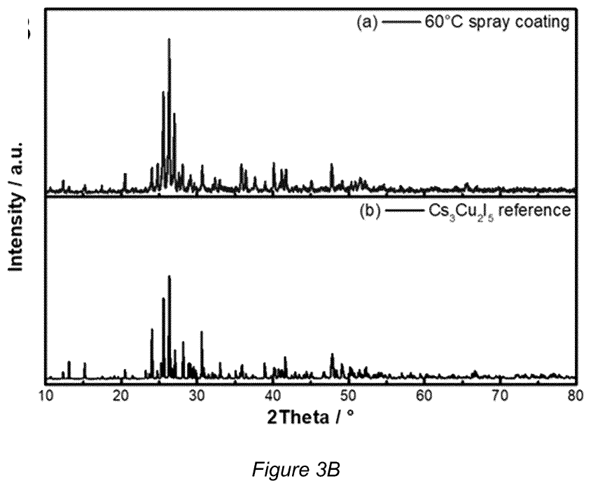

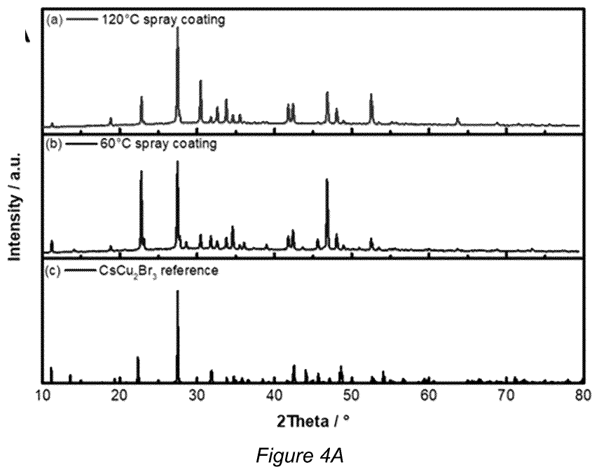

FIGS. 3A and 3B show the X-ray diffraction patterns of the scintillation films discussed in relation to plots A and B, respectively, in FIG. 2.

As is apparent from FIGS. 3A and 3B, the X-ray diffraction measurements prove that the desired crystallographic phases were formed with the spray coating technique of method A with no need for any additional annealing steps.

### (C) Demonstration of X-Site Anion Exchange in Scintillation Films Obtained by Method A

In this example, the effects of changing the precursor solution composition as to the X-site chemical element used to prepare exemplified scintillation films are discussed in more detail.

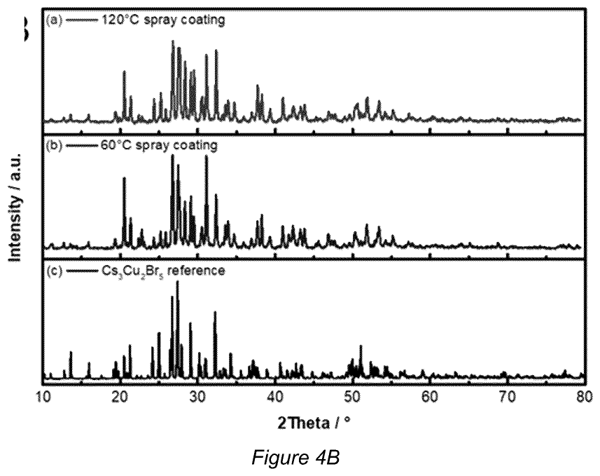

FIGS. 4A and 4B show the X-ray diffraction patterns of a CsCu₂Br₃ film and a Cs₃Cu₂Br₅ film, respectively, obtained with changing the precursor solution compositions used to prepare the films as to the X-site chemical element from iodine to bromine.

As is apparent from FIGS. 4A and 4B, the X-ray diffraction measurements prove that by changing the precursor solution composition, the spray coating technique of method A can be extended to prepare scintillation film variants with different X-site anions, such as e.g. bromide in this case.

Phase pure scintillation films can be obtained in a wide temperature range.

### (D) Demonstration of A-Site Cation Exchange in Scintillation Films Obtained by Method A

In this example, the effects of changing the precursor solution composition as to the A-site chemical element used to prepare exemplified scintillation films are discussed in more detail.

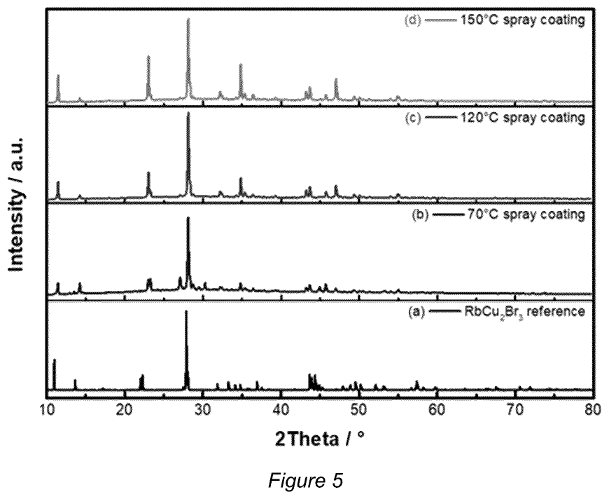

FIG. 5 illustrates the X-ray diffraction pattern of spray-coated RbCu₂Br₃ films obtained with changing the precursor solution composition used to prepare the films as to the A-site chemical element caesium to rubidium. To prepare said RbCu₂Br₃ films, an acetonitrile-based solution containing 7.5 V/V % water at various spray coating temperatures (see plots (b) to (d)) is used. FIG. 5 (plot (a)) also shows the simulated reference pattern for a RbCu₂Br₃ scintillation film.

As is apparent from FIG. 5, X-ray diffraction measurements prove that by changing the precursor solution composition, the spray coating technique of method A can be extended to prepare scintillation film variants with different A-site cations, such as e.g. rubidium in this case.

Phase pure scintillation films can be obtained in a wide temperature range, and at least in the range of about 70-150° C.

As is also apparent from FIGS. 2 to 5, preparation method A results in dopant-free copper-based perovskite-analogue inorganic thin-films of polycrystalline nature.

### Example 2

### (A) Structural Characterization of Powdery Luminescent Substances Obtained by Method B

In this example, crystallographic properties of some exemplified powdery substances for scintillation films prepared by method B are discussed in more detail.

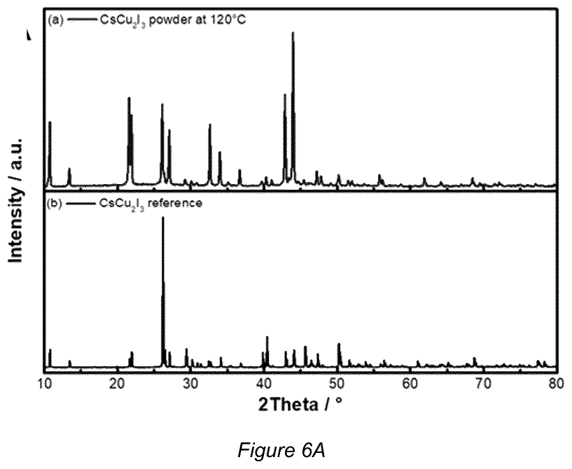

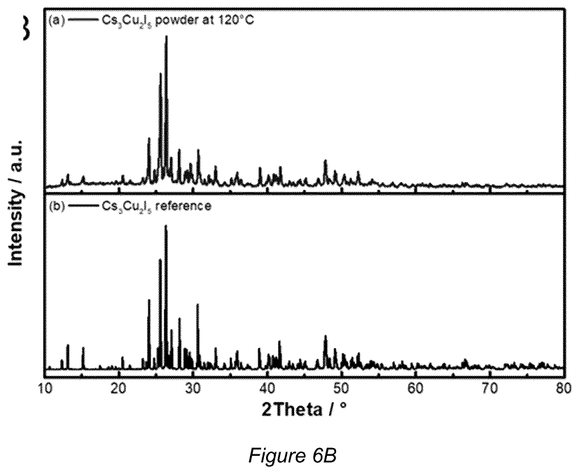

FIGS. 6A and 6B show the X-ray diffraction patterns of the powdery substances CsCu₂I₃ and Cs₃Cu₂Is, respectively, for scintillation films both prepared by the evaporation technique of method B. To prepare the CsCu₂I₃ film, an acetonitrile-based solution containing 7.5 V/V % water at an evaporation temperature of 120° C. is used. To prepare the Cs₃Cu₂I₅ film, an acetonitrile-based solution containing 5.5 V/V % water at an evaporation temperature of 120° C. is used. As can be seen in FIGS. 6A and 6B, the X-ray diffraction measurements prove that the desired crystallographic phases were formed with the evaporation of the solvent mixture at 120° C. according to method B.

Phase pure and polycrystalline substances for scintillation films can be obtained with method B, wherein the substance CsCu₂I₃ is preferentially oriented. This paves the way for the possible large-scale synthesis of the substances, and hence the scintillation films.

Since method B seems to work well, additional preparation techniques become viable options. In particular,
by preparing pastes with the use of various organic solvents (e.g., 1-nonanol), the doctor blade technique becomes a viable route to prepare thick self-standing films essentially in a single turn; and
the preparation of concentrated suspensions in other organic media also becomes an option.

### (B) Demonstration of X-Site Anion Exchange in Scintillation Films Obtained by Method B

In this example, the effects of changing the precursor solution composition as to the X-site chemical element used to prepare exemplified powdery substances are discussed in more detail.

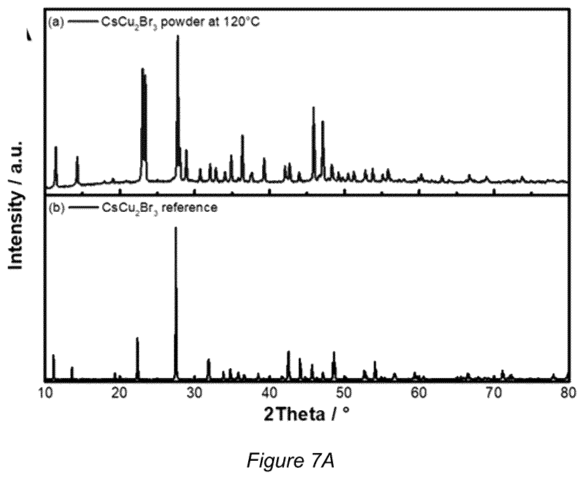

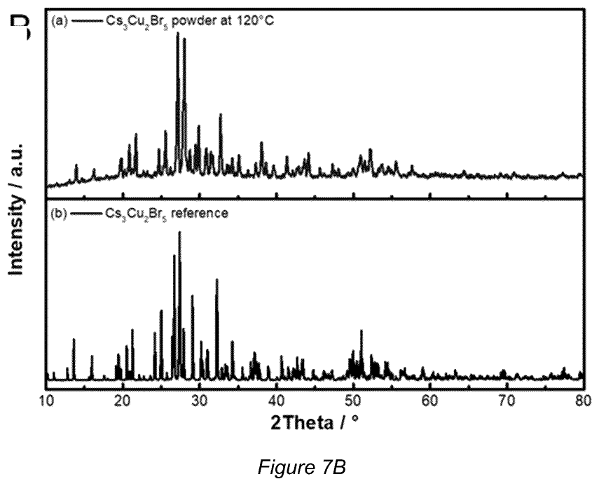

FIGS. 7A and 7B show the X-ray diffraction patterns of the substance CsCu₂Br₃ and the substance Cs₃Cu₂Br₅, respectively, obtained with changing the precursor solution compositions used to prepare the substances as to the X-site chemical element from iodine to bromine.

As apparent from FIGS. 7A and 7B, the X-ray diffraction measurements prove that by changing the precursor solution composition, the evaporation technique of method B can be extended to prepare powdery substance variants with different X-site anions, such as e.g. bromide in this case.

### Example 3

In this example, crystallographic characterization of a CsCu₂I₃ scintillation film obtained by Method C, i.e. with the doctor blade technique, is discussed in more detail.

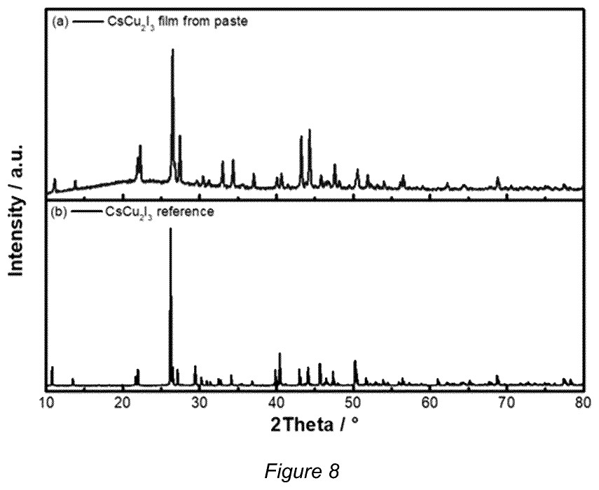

FIG. 8 shows the X-ray diffraction pattern of the studied CsCu₂I₃ scintillation film. To obtain the film, the powdery luminescent substance prepared by method B was suspended in 1-nonanol and then dried on a hotplate at a temperature of about 120° C.

As is apparent from FIG. 8, preparation method B results in a dopant-free copper-based perovskite-analogue inorganic CsCu₂I₃ film of polycrystalline nature.

### Example 4

In this example, compositional characteristics of spray-coated scintillation films are discussed in more detail.

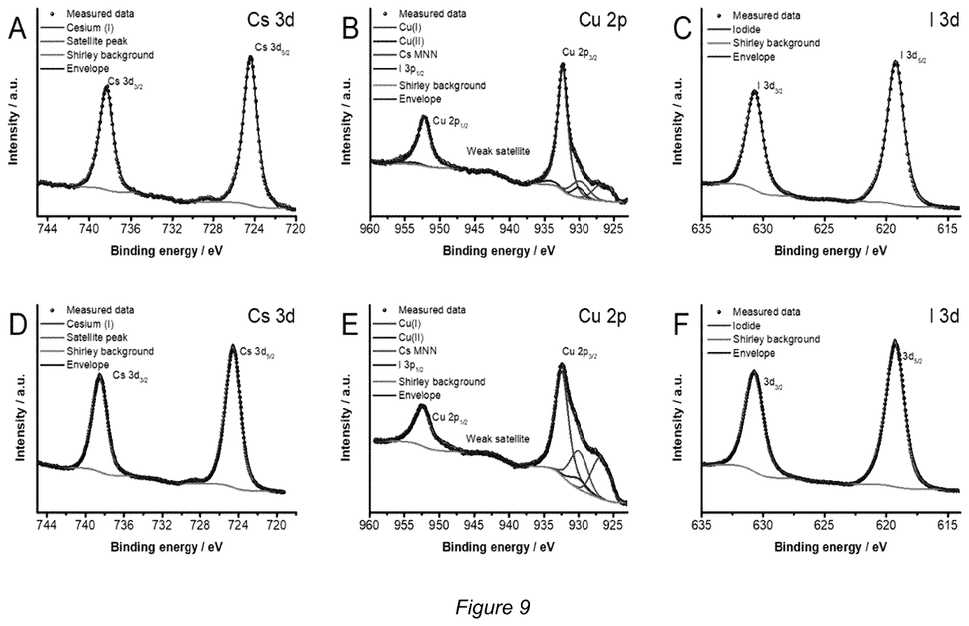

FIG. 9 presents the compositional characteristics of CsCu₂I₃ scintillation films (plots A to C) and Cs₃Cu₂I₅ scintillation films (plots D to F) equally prepared by method A.

The recorded X-ray photoelectron spectra show that a surface composition of CsCu_{1.7}I_{2.9} and Cs₃Cu_{1.6}I_{3.9} can be determined for the materials CsCu₂I₃ and Cs₃Cu₂I₅, which is in good agreement with the expected compositions from the precursor concentrations in the precursor mixture composition used in method A.

### Example 5

### (A) Spectral Characterization of Photoluminescence

In this example, photoluminescent properties of the scintillation films formed by the above-referred preparation methods are discussed in more detail.

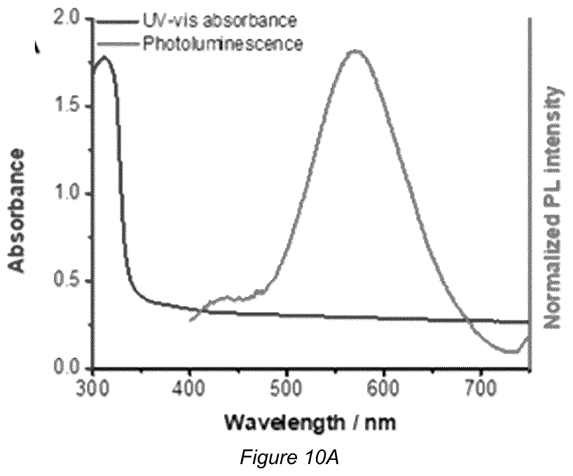

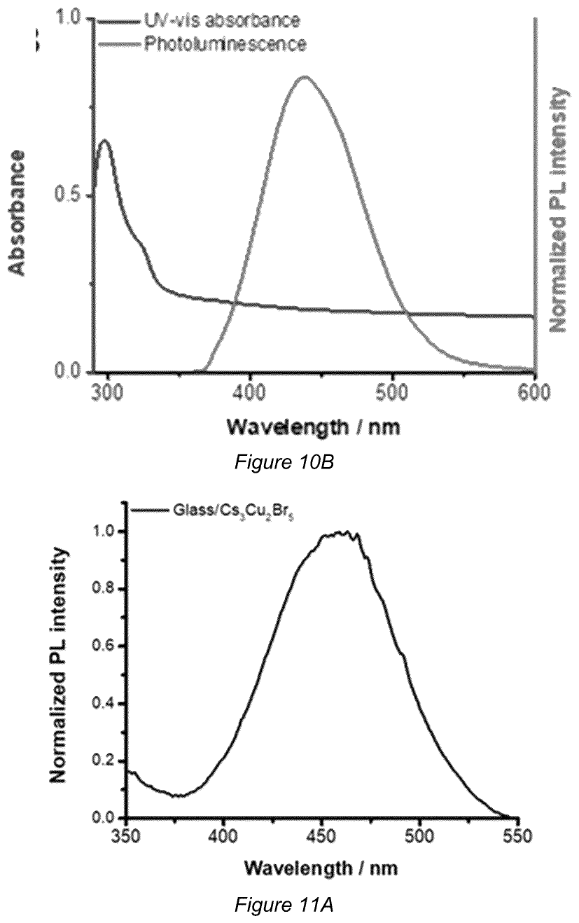

FIGS. 10A and 10B illustrate the UV-visible absorption and the photoluminescence spectra together of an exemplified CsCu₂I₃ scintillation film with a film-thickness of 0.9 μm and a further exemplified Cs₃Cu₂I₅ scintillation film with a film-thickness of 1.2 μm, respectively, both prepared by method A discussed before. The excitation wavelength is 300 nm in all cases.

As is apparent from FIGS. 10A and 10B, a large Stokes shift is present in both cases, which makes the layers transparent in the region of luminescence, thereby minimizing the light loss of photoluminescence signals (also radioluminescence signals, as seen later), and thus maximizing the photon collection efficiency of the films.

Hence, the scintillation films prepared by the preparation methods A to C, in particular the spray coating process according to the invention are ideal candidates for being used in particle detectors/scintillators to detect charged particles.

It should be here also noted that the luminescence peaks have different positions for the films with different stoichiometric compositions. That is, the substance CsCu₂I₃ emits in green, and the substance Cs₃Cu₂I₅ emits in blue.

### (B) Effects of X-Site Anion and A-Site Cation Exchange in Scintillation Films on Photoluminescence Properties

In this example, the effects of X-site anion and A-site cation exchange in scintillation films on photoluminescence properties are discussed in detail.

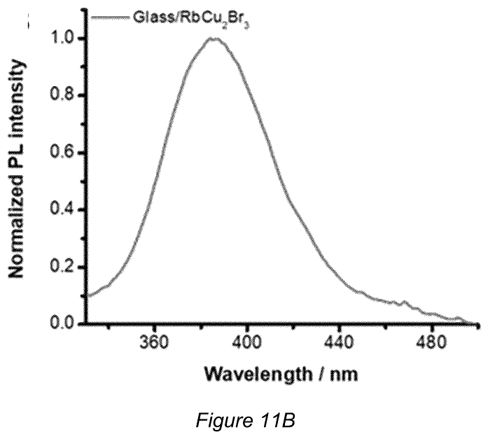

FIGS. 11A and 11B present steady-state photoluminescence of an exemplified spray-coated Cs₃Cu₂Br₅ scintillation film and a further exemplified spray-coated RbCu₂Br₃ scintillation film, respectively, at the excitation wavelength of 300 nm. Both films are arranged on glass substrates.

As is apparent from FIG. 11A when compared with corresponding FIG. 10B, the anion exchange shifts the position of the luminescence peak to lower wavelengths. Thus, the prepared Cs₃Cu₂Br₅ scintillation films emit in blue.

As is apparent from FIG. 11B when compared with corresponding FIG. 10A, the cation exchange also shifts the position of the luminescence peak to lower wavelengths. Thus, the prepared RbCu₂Br₃ scintillation films emit in blue.

### Example 6

### (A) Decay Lifetime of Photoluminescence

In this example, the decay lifetime of photoluminescence in scintillation films prepared by the above-referred spray coating technique of method A are discussed.

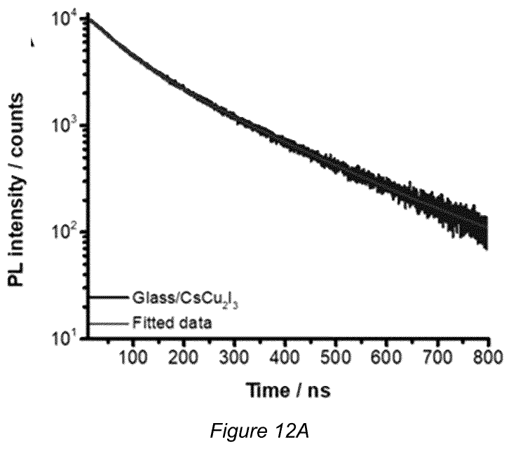

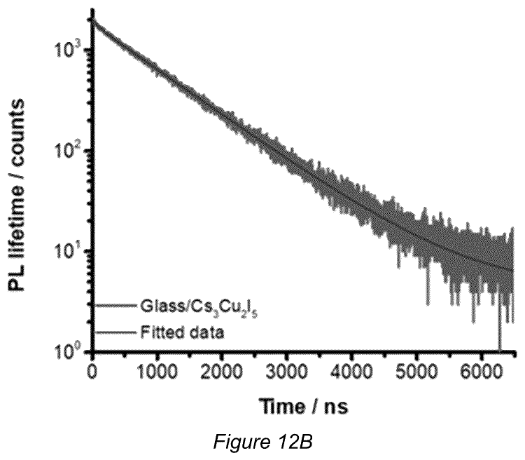

FIGS. 12A and 12B illustrate the results of photoluminescence decay measurements of CsCu₂I₃ scintillation films, on glass, at 570 nm and Cs₃Cu₂I₅ scintillation films, also on glass, at 440 nm, respectively. The excitation wavelength is 300 nm in all cases.

The luminescence lifetime was measured for the substances prepared. The average experimental photoluminescence lifetimes for the substances on glass are 129±2 ns (˜62 ns from literature) and 864±19 ns (˜970 ns from literature) for CsCu₂I₃ and Cs₃Cu₂I₅ scintillation films, respectively.

### (B) Effects of X-Site Anion and A-Site Cation Exchange in Scintillation Films on Photoluminescence Decay Lifetimes

In this example, the decay lifetime of photoluminescence in scintillation films prepared by the above-referred spray coating technique of method A are discussed.

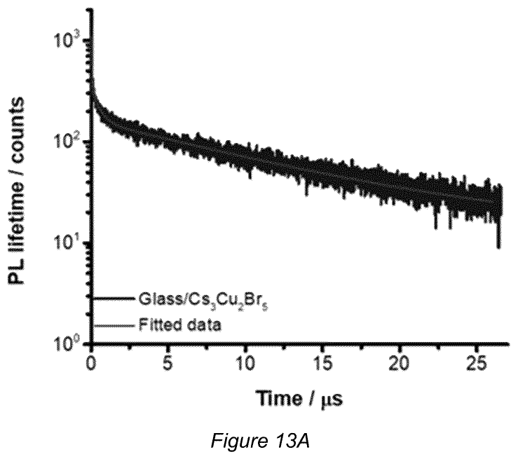

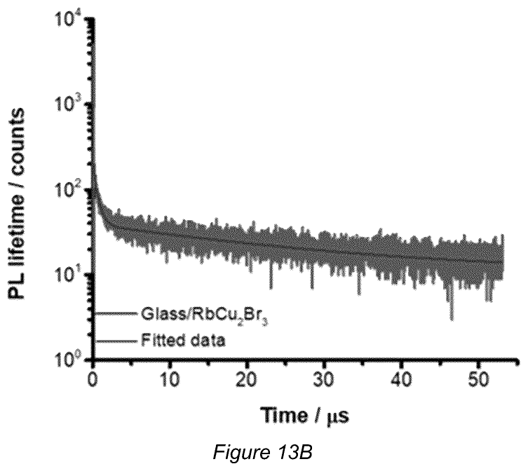

FIGS. 13A and 13B show the results of photoluminescence decay measurements of Cs₃Cu₂Br₅ scintillation films, on glass, at 450 nm and RbCu₂Br₃ scintillation films, also on glass, at 400 nm, respectively. The excitation wavelength is 300 nm in all cases.

As is clear from FIGS. 13A and 13B, generally, longer lifetime is measured for the A-site and X-site exchanged substances.

In what follows, radioluminescence measurements of some exemplified scintillation films and the measurement data are discussed and explained in more detail.

### Example 7

### (A) Pulse Waveform: Decay Curves

In this example, pulse waveforms of 5.5 MeV α-particles are recorded by scintillation units according to the present invention, which composed of Cs₃Cu₂I₅ and CsCu₂I₃ films, photomultiplier tubes (PMT, model 9813B, ET Enterprises, UK), and pulse waveform digitizers (500 MS/s CAEN1370, 4 GS/s CAEN5761, CAEN S.p.A., Italy). Waveforms are compared to those obtained by a commercially available doped CsI(Tl) scintillator. The α-particles are emitted by an Am-241 radioactive source.

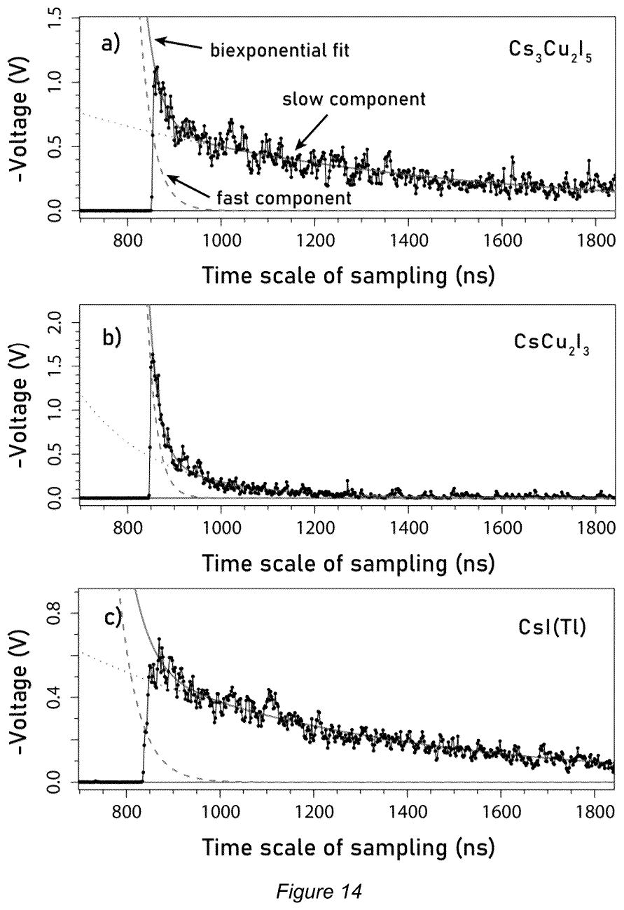

FIG. 14 shows some examples of typical pulse waveforms recorded for Cs₃Cu₂I₅ (plot a) and CsCu₂I₃ (plot b) compositions and a doped CsI(Tl) scintillator (plot c).

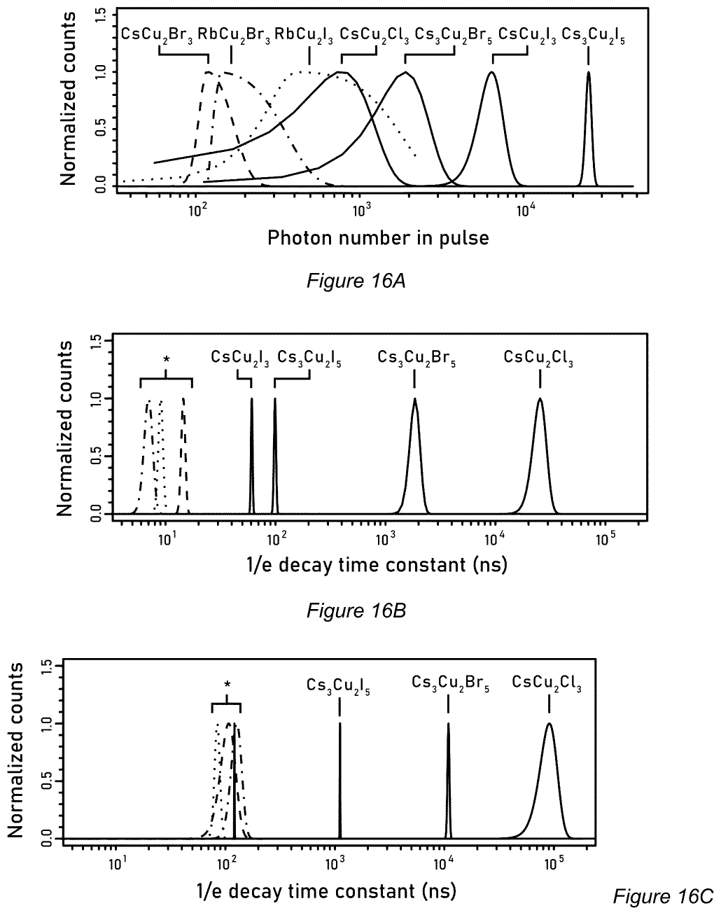

The here exemplified Cs₃Cu₂I₅ and CsCu₂I₃ compositions are prepared in accordance with preparation method A discussed above. The decay of the pulse waveforms is analysed with a standard biexponential model identifying fast and slow decay components as often observed when exciton recombination processes follow multiple pathways of evolution. In the plots of FIG. 16, the slow components (see FIG. 16C) and the fast components (see FIG. 16B) of the biexponential model fit (solid line) are drawn by dotted and dashed lines, respectively; the decay of the CsI(Tl) waveform follows a monoexponential decay.

In Table 1, decay times obtained by the biexponential fit decomposing the waveforms to fast and slow components are presented. The waveforms were recorded for various perovskite-analogue inorganic compositions prepared by preparation method A. The data in brackets represent standard deviation obtained by the statistical evaluation of biexponential fit on the waveform of individual particle incidences. In the data, the common systematic error is estimated to be about 10% comprising the complex effect of physical conditions of measurements, layer quality, as well as variations in operational parameters of the detection apparatus.

As is apparent from the data, in case of the Cs₃Cu₂X₅ materials family, the exchange of iodide to bromide in the lattice increases the overall radioluminescence lifetime (both fast and slow components). In stark contrast, this exchange has an opposite effect in case of the CsCu₂X₃ materials family. A further reduction in the lifetime is achieved by exchanging the A-site cation from Cs to Rb in the case of A_{y}B_{1-y}Cu₂I₃ luminescent substances. The decay time constants are spread in a broad range of the time scale in three orders of magnitude, which offer a unique flexibility in engineering the scintillator response by compositional tuning. That is, by changing the material composition of the dopant-free copper-based perovskite-analogue inorganic substances the radioluminescence lifetime can be tuned to meet the specific needs of experimental design in which the given substance is to be involved. This is an outstanding and unexpected feature of perovskite-analogue compositions described by the present invention.

TABLE 1
Decay time constants of some perovskite-
analogue inorganic compositions.

| Composition | Slow component (ns) | Fast component (ns) |
|---|---|---|
| Cs₃Cu₂I₅ | 979 (7) | 88 (2.5) |
| CsCu₂I₃ | 121 (0.6) | 61 (1.5) |
| Cs₃Cu₂Br₅ | 7146 (156) | 807 (38) |
| CsCu₂Br₃ | 107 (17) | 14.5 (0.7) |
| CsCu₂Cl₃ | 90920 (16320) | 25470 (3560) |
| RbCu₂I₃ | 84.4 (4.8) | 9.0 (0.5) |
| RbCu₂Br₃ | 127 (14) | 7.0 (0.7) |

### (B) Pulse Waveform: Rising Edge

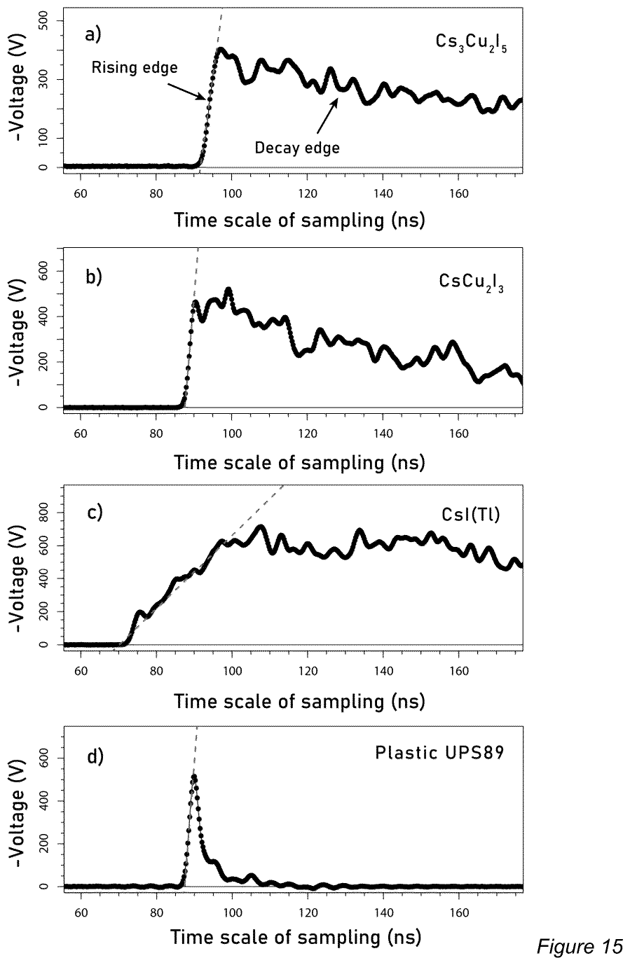

The rising edges of the waveforms also show considerable differences as depicted in the plots of FIG. 15. The characteristic time scale of rising slopes is close to the single electron rise time of the photomultiplier tube (PMT) specifications (˜2 ns), while the activator-assisted CsI(Tl) scintillator shows nearly an order of magnitude larger (i.e., slower) rising time and an undulated edge shape. Comparing the rising edge behaviour in case of a plastic scintillator (UPS89, AmCrys, USA) a similarly fast rising time is found as in case of the copper-halide perovskite-analogue inorganic films, however, the pulse waveform cannot be confidently distinguished from dark pulses of the PMT, and therefore the weak scintillation yield cannot provide the sufficient information for charged particle identification and spectroscopy.

The timing information of single particle detection is obtained from the electronic time stamp of the waveform record and constant-fraction threshold crossing position of the rising edge. The electron multiplication of the photomultiplier is determined from the single electron spectrum recorded for α-particle induced waveforms of Cs₃Cu₂Br₅ possessing well-separated single photon peaks.

### Example 8

In this example, pulse waveform characteristics of charged-particle induced radioluminescence response recorded for various selected perovskite-analogue inorganic compositions used in charged particle scintillation units according to the present invention are shown.

The scintillation yield is determined by the full integration of the pulse charge and conversion to the number of photons. The calculation involves the calibrated electron multiplication of the photomultiplier tube and the quantum efficiency of the photocathode that sensitively depends on the photoluminescent spectrum of the perovskite-analogue compositions. Measurements are carried out using an α-emitter Am-241 source placed at a fixed distance from the scintillator layer to deliver 5 MeV particles. Data acquisition is based on the 500 MS/s pulse shape digitizer (CAEN V1730, CAEN S.p.A., Italy) directly connected to the anode output of the photomultiplier tube (PMT, model 9813B, ET Enterprises, UK). The applied high voltage is −1800 V for the Cs₃Cu₂I₅ layer and −2000 V for all the other layers.

FIG. 16A shows the statistical distribution of the scintillation yields in terms of photon number, while FIGS. 16B and 16C present the 1/e decay time constants for the same selected material compositions for the biexponential fit used, respectively.

As is apparent from FIGS. 16B and 16C, the decay times range over three orders of magnitude depending on the material composition (see also Table 1).

### Example 9

In this example, the effect of film-thickness on the recorded pulse shape is illustrated.

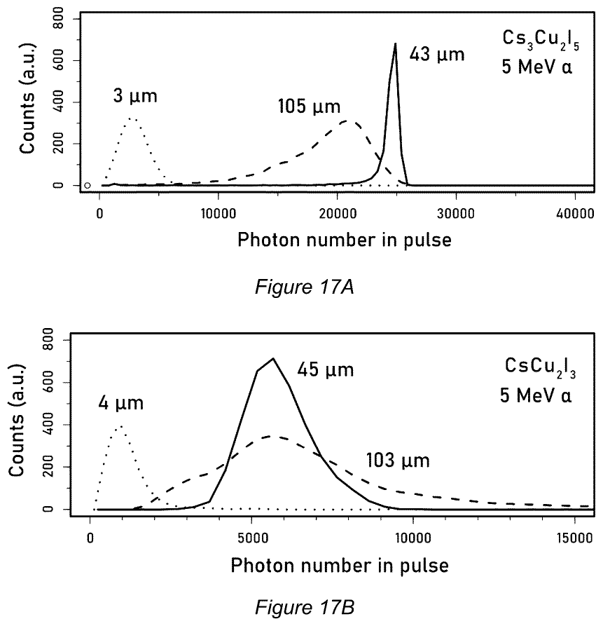

FIGS. 17A and 17B present the scintillation yield distributions of radioluminescence pulses obtained from exemplary Cs₃Cu₂I₅ and CsCu₂I₃ films, respectively, used in charged particle scintillation units according to the present invention. The radioluminescence pulses are generated by using an α-emitter Am-241 source placed at a fixed distance from the scintillator film to deliver 5 MeV particles. The distributions were recorded for different scintillator layer thicknesses. The scintillation yields are calculated from the full integration of pulses in each recorded radiation event.

Taking into account that the stopping range of 5-MeV α-particles in the presented perovskite-analogue materials ranges from 20 μm to 30 μm, and is typically 25 μm, layers with thicknesses lower than the stopping range cannot absorb the full kinetic energy of the particles, hence the scintillation yield primarily depends on the effective layer thickness. If the layer thickness is larger than the stopping range, the scintillation yield is an appropriate measure of the particle energy. In both cases, the incidence of charged particles can be measured independently of the evaluation of the scintillation yield.

In contrast, radiation energy in X-ray detection cannot be extracted from the scintillation yield due to the probabilistic nature of X-ray absorption and the obvious fact that a major part of the radiation energy escapes from thin-layer scintillators.

### Example 10

In this example, the effect of charged-particle type on the recorded pulse shape is illustrated.

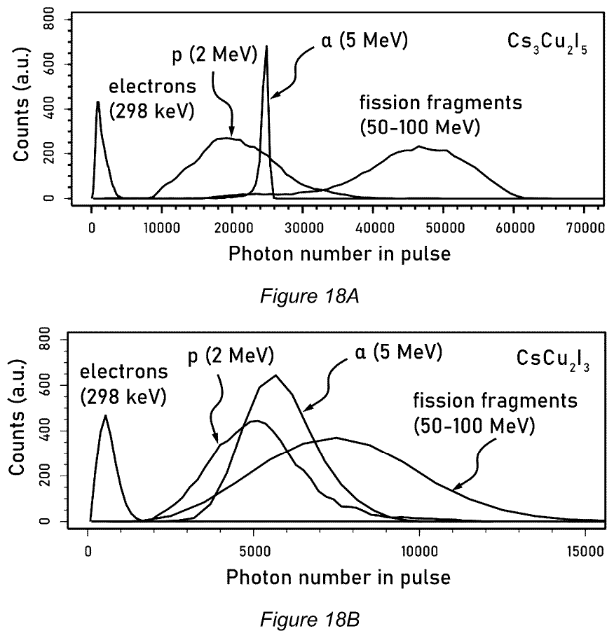

FIGS. 18A and 18B present the scintillation yield distributions of radioluminescence pulses from exemplary Cs₃Cu₂I₅ and CsCu₂I₃ films, respectively, excited by different charged-particle types from either radioactive radiation sources or accelerators. The applied film-thicknesses are 43 μm and 45 μm for the Cs₃Cu₂I₅ and CsCu₂I₃ compositions, respectively. Here, electrons of 298 keV are emitted by a Tc-99 β-source, protons of 2 MeV are delivered by a Tandetron linear accelerator using a 25-μm diameter aperture to downscale the beam current, α-particles of 5 MeV are emitted by an Am-241 source positioned at a fixed aerial distance from the scintillator film, and fission fragments are emitted by a target containing U-235 nuclei in proton-induced nuclear fission. In the fission experiment, protons of 12 MeV are delivered by a cyclotron. The fission fragments has got a flight path in vacuum at a distance of 17 cm from the U-235 target at a perpendicular geometry with respect to the beam axis.

As is shown in FIGS. 18A and 18B, the scintillation yield exhibits a strong non-linearity as a function of particle kinetic energy, which might be related to the subtle energy transfer processes between the electronic and atomic structures during deceleration of the incident charged particles within the scintillation films. At higher mass of charged particles and at lower momenta, the nuclear recoil is the prevalent energy loss mechanism, which decreases the radiative efficiency of the scintillator with respect to light charged particles, for example protons, which deposit their kinetic energy in electronic processes leading eventually to the effective generation of radiative excitonic states.

### Example 11

### (A) Spectroscopic Linearity of Scintillation Yield

In this example the effect of charged particle energy on the linearity of mean scintillation yield is illustrated.

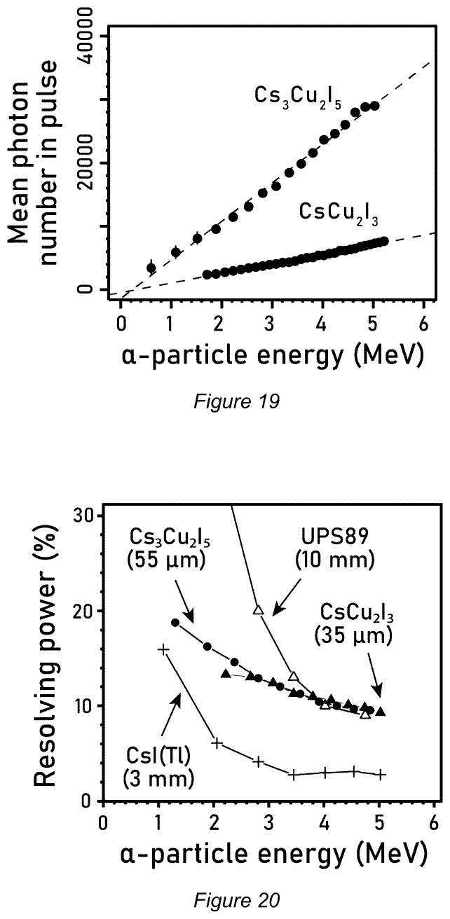

FIG. 19 shows the linear behaviour of mean scintillation yield of a particles as a function of incident particle energy for exemplary Cs₃Cu₂I₅ and CsCu₂I₃ films with thicknesses of 43 and 45 μm, respectively. The kinetic energy of a particles emitted by an Am-241 source is adjusted with the stepwise variation of the aerial distance to the scintillator layer.

### (B) Energy Resolving Power of Scintillation Yield

In this example the energy resolving power of mean scintillation yield is illustrated for various types of scintillators.

FIG. 20 shows the energy resolving power of mean scintillation yield as a function of incident particle energy for exemplary Cs₃Cu₂I₅ and CsCu₂I₃ films with thicknesses of 55 and 35 μm, respectively, a doped CsI(Tl) scintillator with a thickness of 3 mm, and a plastic scintillator (UPS89, AmCryst, USA) with a thickness of 10 mm. The energy resolving power is defined by the ratio of standard deviation and mean of scintillation yield distributions.

As can be seen in FIG. 20, the Cs₃Cu₂I₅ scintillator exhibits intermediate resolving power values over a wide range of α-particle energy. In the lower part of the measured kinetic energy range, the Cs₃Cu₂I₅ scintillator of 43 μm film-thickness is superior to organic scintillators as exemplified with the plastic scintillator UPS89, due to the low scintillation yield and detection efficiency of the latter.

FIG. 20 clearly demonstrates that the Cs₃Cu₂I₅ scintillator unit according to the present invention simultaneously offers high detection efficiency, which is close to unity, high timing precision and moderate energy resolving power. According to the extensive studies performed with further perovskite-analogue inorganic substances (see e.g. Table 1 and FIG. 16), this is a general property of the class of perovskite-analogue substances, which makes them ideal for being used in scintillation units for charged particle detection.

### Example 12

In this example detection of fission fragments is illustrated.

FIG. 23 shows the 2-D distribution by correlating the time difference measured between two fission fragments that are detected in a double-arm experimental arrangement (see FIG. 22; measurement setup 200) and the scintillation yield determined by the full integration of the pulse waveform. The fission fragments are emitted by a target containing U-235 nuclei in proton-induced nuclear fission. In the fission experiment, protons of 12 MeV are delivered by a cyclotron. The fission fragments have got a flight path in vacuum at a distance of 17 cm from the U235 target at a perpendicular geometry with respect to the beam axis.

The example apparently illustrates the resolving power of the scintillator units constructed of perovskite-analogue inorganic substances, as exemplified with the Cs₃Cu₂I₅ composition and photomultiplier tubes (PMT, model 9813B, ET Enterprises, UK), which allows the distinction between light and heavy fission fragment components, and a moderate determination of the fission fragment mass. The example also illustrates the applicability of the presented scintillator unit in heavy-ion detection experiments.

### Example 13

In this example the afterglow properties of Cs₃Cu₂I₅ thin-film scintillators are demonstrated.

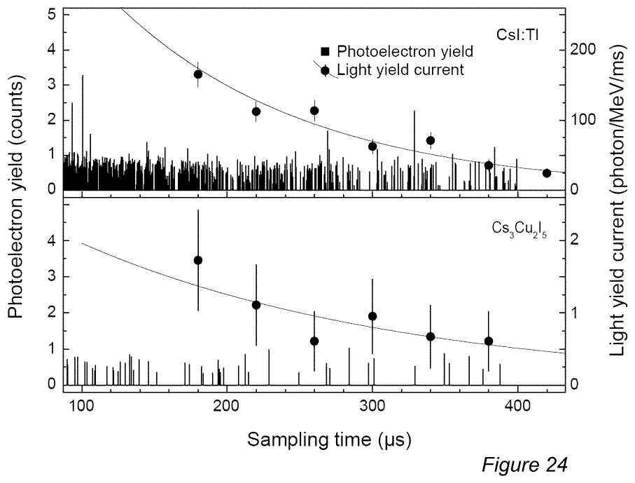

Radioluminescence yield intensity was measured on an extended time scale following the scintillation pulse that comprises at least 99% of total light yield. In FIG. 24 the 100-400 us range scintillation yield of Cs₃Cu₂I₅ thin film is shown in comparison with the scintillation yield of CsI(Tl) under identical measurement conditions. The scintillation yield can be approximated with a mono-exponential decay curve in both cases. The example demonstrates the low level of afterglow intensity of a scintillation unit according to the present invention prepared with a Cs₃Cu₂I₅ thin-film as the luminescent substance. This property suggests that the scintillation units according to the invention are ideal candidates to replace traditional bulk type scintillation units in charged particle detection processes.

### Example 14

In this example, the scintillation pulses are demonstrated for various Cs₃Cu₂X₅ (X=Br, I) compositions.

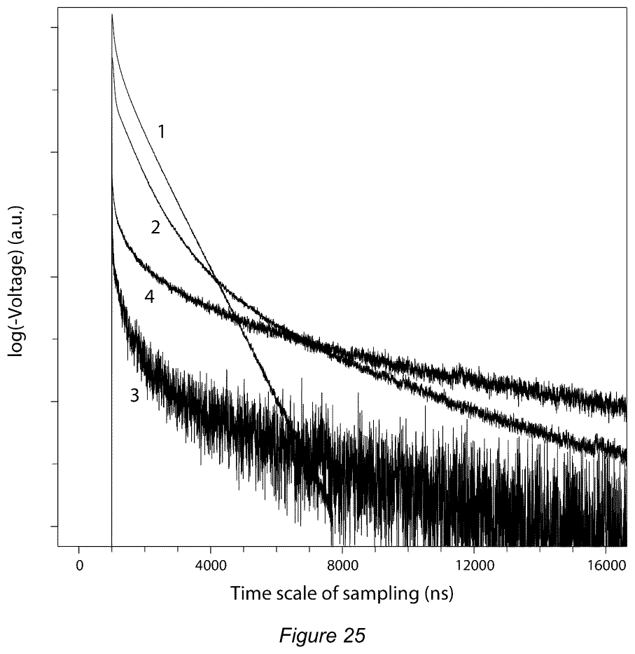

The scintillation pulses were induced with an Am-241 alpha source. The waveforms denoted with the symbols (1), (2), (3), and (4) correspond to the various compositions Cs₃Cu₂I₅, Cs₃Cu₂Br_{1.25}I_{3.75}, Cs₃Cu₂Br_{2.5}I_{2.5}, and Cs₃Cu₂Br_{3.75}I_{1.25}, respectively. The scintillation pulse waveforms of thin-film scintillators built with mixed halogen compositions Cs₃Cu₂X₅ (X=Br, I) were also recorded. The averaged waveforms presented in FIG. 25 exhibit a complex decay behavior depending on the relative amount of the halogen content. Without going into theoretical details, the contributions of the fast and slow decay components, as well as the scintillation light yields are presumably attributed to subtle processes of energy deposition and excitonic dynamics.

### Example 15

In this example the spectroscopic potentials of using Cs₃Cu₂I₅ thin-film scintillators are demonstrated.

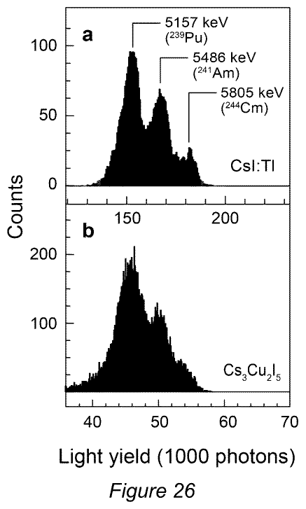

FIG. 26 illustrates the comparison of scintillation light yields of a traditional CsI(Tl) bulk crystal and the Cs₃Cu₂I₅ thin-film. Here, the scintillation pulses were induced with a mixed alpha source routinely used for spectroscopic calibration and resolution tests in nuclear measurements. The energy resolving power of the Cs₃Cu₂I₅ thin-film is comparable to that of the bulk CsI(Tl) scintillator, which makes the former beneficial for measurement solutions, especially when the replacement of techniques with poor resolving power, e.g. of ionization chambers is desired.

### SUMMARY

Hereby, the application of thin-films of dopant-free copper-based perovskite-analogue inorganic luminescent compositions is proposed as scintillators for particle-selective detectors with sufficient luminosity for measuring individual radiation events and formed with a film-thickness of 1-100 μm, preferably at least about 5 μm, more preferably at least about 20 μm, and even more preferably at least about 25 μm. The use of the material compositions, the thin-film deposition techniques applied on transparent substrates, and the combination with signal processing technique are discussed above in detail.

In comparison with existing charged particle detection methods, prior art methods involve the usage of either semiconductor-based charge collection devices (type I), or single crystal-based bulk scintillators (type II), or organic-based scintillators (type III). The present invention overcomes the shortcomings of the listed techniques as it provides:
low costs in contrast to type I and type II solutions;
better timing precision in contrast to type I and type II solutions;
higher light yield and higher detection efficiency in contrast to type III solutions;
insensitivity to background radiation, e.g. γ-radiation, which results in higher confidence of particle detection and suppressed load of data acquisition;
applicability under harsh environmental conditions (vacuum, temperature, nonpolar solvents) in contrast to type III solutions;
radiation tolerance in contrast to type I and type III solutions;
production steps to be performed under ambient conditions, that is, in the presence of water and/or oxygen in the melting phase of the film preparation;
handling of phase-pure compositions during the film preparation;
the applicability of plastics with low melting points as substrates; and
flexible geometry and assembly in contrast to type I and type II solutions.

Furthermore, the scintillator unit according to the present invention exhibits characteristics competitive with those of commercial detection techniques. In particular, its
timing precision is similar to that of type III and some type II solutions;
manufacturing costs are similar to those of type III solutions;
energy resolution is moderate, similar or occasionally below to that of type II solutions, and similar to that of type III solutions, and generally below to that of type I solutions;
energy linearity is similar to that of type I and type II solutions, and occasionally—depending on the composition—better than that of type III solutions;
detection efficiency is similar to that of type I and type II solutions.

Due to the very low probability of photon absorption, the application of dopant-free copper-based perovskite-analogue inorganic compositions in the form of thin films as scintillation detectors in case of X-ray and gamma scintillation gives no hints at all to the skilled artisan as to the viability the of said compositions in applications as scintillation detectors for charged particle radiation detection. The collisional process between the charged particles to be detected and the constituent atomic species of the scintillator material is of partly nuclear nature, which gets dominant with increasing particle mass, eventually decreases the scintillation yield, and thereby impedes the confidence of single particle event detection. In light of this, the use of perovskite-analogue compositions as thin-film scintillators for detecting charged particles, especially heavy ions, more preferably fission fragments, as well as determining spectroscopic information is not obvious either.

Our findings have also revealed that pulse detection technique in combination with copper-halide perovskite-analogue scintillators is an adequate tool for the individual detection of charged particles, especially for protons with the energy of at most about 2 MeV, i.e. E≤2 MeV, more specifically for charged particles with E/A<1 MeV/amu, and more specifically for heavy ions with A>4 amu.

The analysis of scintillation pulses of single particle events with pulse shape digitization is used to quantify timing and luminosity characteristics of thin-film scintillators, which is claimed to exploit most advantages of the dopant-free copper-based perovskite-analogue inorganic compositions discussed above in single-particle detection of charged particles in contrast to charge integration devices.

1. A charged-particle scintillation unit, the scintillation unit comprising a perovskite-analogue luminescent substance with a luminescent peak of a general chemical formula of either AₓB₃₋ₓCu₂X_{y}Y_{5-y} with 0≤x≤3, 0≤y≤5 or AₓB₁₋ₓCu₂X_{y}Y_{3-y} with 0≤x≤1, 0≤y≤3, wherein any of A and B is a monovalent alkali metal cation, and any of X and Y is a monovalent halogen element anion or a pseudohalide, arranged on a substrate as polycrystalline thin-film having a given film-thickness, the substrate being transparent at least in a wavelength range of the luminescent peak of the luminescent substance.

2. The scintillation unit of claim 1, wherein the monovalent alkali metal cation is selected from a group consisting of caesium and rubidium.

3. The scintillation unit of claim 1, wherein the monovalent halogen element anion is selected from a group consisting of chlorine, bromine and iodine.

4. The scintillation unit of claim 1, wherein the substrate is made of a material selected from a group consisting of glass quartz, and plastics.

5. The scintillation unit of claim 1, wherein a film-thickness of the thin-film of the luminescent substance is sufficient to substantially stop charged particles incident upon the thin-film with a kinetic energy ranging from about 298 keV to about 110 MeV.

6. The scintillation unit of claim 5, wherein the film-thickness of the of the luminescent substance is 1-100 μm.

7. The scintillation unit of claim 5, wherein the charged particles are selected from a group consisting of electrons, protons, alpha particles, ionic species of chemical elements of Periodic Table of Elements, ionic species of molecules and fission fragments, all with a unified atomic mass unit of at most 150.

8. The scintillation unit of claim 1, wherein the general chemical formula is AₓB₃₋ₓCu₂X_{y}Y_{5-y} in which x≠3 and y≠5.

9. A use of a charged-particle scintillation unit comprising a perovskite-analogue luminescent substance with a luminescent peak of a general chemical formula of either AₓB₃₋ₓCu₂X_{y}Y_{5-y} with 0≈x≤3, 0≤y≤5 or AₓB₁₋ₓCu₂X_{y}Y_{3-y} with 0≤x≤1, 0≤y≤3, wherein any of A and B is a monovalent alkali metal cation, and any of X and Y is a monovalent halogen element anion or a pseudohalide, arranged on a substrate as polycrystalline thin-film having a given film-thickness to detect charged particles with kinetic energy ranging from about 298 keV to about 110 MeV by stopping said charged particles within the thin-film of the luminescent substance, the substrate being transparent at least in a wavelength range of the luminescent peak of the luminescent substance.

10. The use of a scintillation unit according to claim 9, wherein the monovalent alkali metal is selected from a group consisting of caesium and rubidium.

11. The use of a scintillation unit according to claim 9, wherein the monovalent halogen element is selected from a group consisting of chlorine, bromine and iodine.

12. The use of a scintillation unit according to claim 9, wherein the substrate is made of a material selected from a group consisting of glass, fluorine-doped tin oxide coated glass, quartz, and plastics.

13. The use of a scintillation unit according to claim 9, wherein a film-thickness of the thin-film of the luminescent substance is chosen to substantially stop charged particles incident upon the thin-film with a kinetic energy ranging from about 298 keV to about 110 MeV.

14. The use of a scintillation unit according to claim 13, wherein the film-thickness of the thin-film of the luminescent substance is 1-100 μm.

15. The use of a scintillation unit according to claim 9, for energy resolved detection of charged particles.

16. The use of a scintillation unit according to claim 9, wherein the charged particles are selected from a group consisting of electrons, protons, alpha particles, ionic species of chemical elements of Periodic Table of Elements, ionic species of molecules and fission fragments, all with a unified atomic mass unit of at most 150.

17. A preparation process to prepare a charged-particle scintillation unit at processing temperatures not higher than 150° C., the scintillation unit comprises a scintillation film on a substrate, comprising:
preparing a luminescent substance with a luminescent peak of a general chemical formula of either AₓB₃₋ₓCu₂X_{y}Y_{5-y} with 0≈x≤3, 0≤y≤5 or AₓB₁₋ₓCu₂X_{y}Y_{3-y} with 0≤x≤1, 0≤y≤3, wherein any of A and B is a monovalent alkali metal cation, and any of X and Y is a monovalent halogen element anion or a pseudohalide;
mixing together acetonitrile and water to obtain a solvent;
dissolving at least one first precursor compound of a general chemical formula chosen from a group consisting of AX and BX and at least one second precursor compound of a second general chemical formula chosen from a group consisting of CuX and CuY in the solvent in a desired stoichiometric ratio corresponding to a stoichiometric composition of the luminescent substance to provide a precursor composition;
forming the scintillation film of a given film-thickness as a polycrystalline thin-film from the obtained precursor composition on at least a portion of the substrate, the substrate being transparent at least in a wavelength range of the luminescent peak of the luminescent substance.

18. The preparation process of claim 17, wherein the monovalent alkali metal cation is selected from a group consisting of caesium and rubidium.

19. The preparation process of claim 17, wherein the monovalent halogen element anion is selected from a group consisting of chlorine, bromine and iodine.

20. The preparation process of claim 17, wherein the substrate is made of a material selected from a group consisting of glass, fluorine-doped tin oxide coated glass, quartz, and plastics.

21. The preparation process of claim 19, wherein the forming the scintillation film further comprises setting a film-thickness of the scintillation film to substantially stop charged particles incident upon the scintillation film with a kinetic energy ranging from about 298 keV to about 110 MeV.

22. The preparation process of claim 21, wherein the film-thickness of the scintillation film is 1-100 μm.

23. The preparation process of claim 17, further comprising heating the substrate to a temperature in a range of 50° C. to 150° C.

24. The preparation process of claim 23, wherein the forming the scintillation film further comprises spray coating the precursor composition onto the substrate.

25. The preparation process of claim 24, wherein the spray coating the precursor composition onto the substrate further comprises repeating the spray coating until the given film-thickness is reached.

26. The preparation process of claim 25, wherein:
the dissolving comprises dissolving the at least one first precursor compound having the general chemical formula AX and another of the at least one first precursor compound of the general chemical formula BX with the at least one second precursor compound of the general chemical formula CuX and another of the at least one second precursor compound of the general chemical formula CuY, and
the preparation process further comprises changing at least one of a composition ratio A to B of the first precursor compounds and a composition ratio X to Y of the second precursor compounds between two consecutive spray coating steps.

27. The preparation process of claim 17, further comprising, before the forming the scintillation film;
evaporating solvent content of the precursor composition to obtain the luminescent substance;
grinding the obtained luminescent substance together with an organic solvent to prepare a viscous paste containing the luminescent substance in powdery form.

28. The preparation process of claim 27, wherein the forming the scintillation film further comprises:
applying the paste on the substrate as a layer by a doctor blade, and
annealing the layer on the substrate at a temperature of about 120° C. and a period of about 10 minutes.

29. The preparation process of claim 28, wherein the organic solvent is 1-nonanol.

30. A charged particle detection device, comprising:
at least one charged-particle scintillator unit (110; 210a, 210b) according to claim 1,
at least one detector (130; 230a, 230b) coupled optically with a respective one of the at least one scintillator unit (110; 210a, 210b) and configured to measure scintillation events created within the respective one of the at least one scintillator unit (110; 210a, 210b) as a consequence of an incoming charged particle (135; 235, 235′) into the respective one of the at least one scintillator unit (110; 210a, 210b) and output an electric signal representative of the incoming charged particle (135; 235, 235′),
at least one signal digitizing unit (160; 260) coupled electrically with the at least one detector (130; 230a, 230b), the at least one signal digitizing unit (160; 260) is configured to digitize the electric signal of the at least one detector (130; 230a, 230b) to create a digitized electric signal, and
a data acquisition unit (170; 270) coupled electrically with the at least one signal digitizing unit (160; 260), the data acquisition unit (170; 270) is configured to record and process the digitized electric signals received from the at least one signal digitizing unit (160; 260).

31. The charged particle detection device of claim 30, wherein the at least one detector (130; 230a, 230b) is chosen from a group consisting of photomultiplier tubes, silicon-based photomultipliers and hybrid photomultipliers.

32. The charged particle detection device of claim 30, wherein the charged particle detection device comprises two charged-particle scintillation units (210a, 210b) with respective ones of the at least one detector (230a, 230b) arranged around a spatial position capable of receiving a radiation source to be investigated by the charged particle detection device, wherein the respective ones of the at least one detector (230a, 230b) form a coincidence circuit to detect coincidental emission events of the radiation source.
